(19) United States
(12) Patent Application Publication
(10) Pub. No.: US 2025/0186903 A1
(43) Pub. Date: Jun. 12, 2025

(54) METHODS OF COATING NATURAL POLYSACCHARIDES ONTO SOLID SUPPORTS AND APPLICATION TO PARTITIONING STUDIES OF MOLECULES

(71) Applicant: The University of Toledo, Toledo, OH (US)

(72) Inventors: Emanuela Gionfriddo, Toledo, OH (US); Nipunika Dhanukshi Hirimuthu Godage, Toledo, OH (US); Madison Williams, Toledo, OH (US)

(73) Assignee: The University of Toledo, Toledo, OH (US)

(21) Appl. No.: 18/975,321

(22) Filed: Dec. 10, 2024

Related U.S. Application Data
(60) Provisional application No. 63/608,458, filed on Dec. 11, 2023.

(51) Int. Cl. B01D 15/16; G01N 1/22; G01N 1/40

(52) U.S. Cl. CPC B01D 15/16; G01N 1/2214; G01N 1/405

(57) ABSTRACT

Microextraction apparatuses, methods for assembling microextraction apparatuses, and methods for using microextraction apparatuses are described. The microextraction apparatuses involve a polysaccharide disposed on a substrate with an optional anchoring material therebetween.

### RELATED APPLICATIONS

This application claims priority to U.S. Provisional Application No. 63/608,458 filed under 35 U.S.C. § 111(b) on Dec. 11, 2023, the disclosure of which is incorporated herein by reference in its entirety.

### STATEMENT REGARDING FEDERALLY SPONSORED RESEARCH

This invention was made with government support under grant number 2144591 awarded by the National Science Foundation. The government has certain rights in this invention.

### BACKGROUND

Several studies have been conducted over the last few decades on the physical properties and chemical composition of the sea-surface microlayer as well as its chemical exchange processes at the air/sea interface. As a result of these studies, it has been demonstrated that a wide variety of xenobiotics are accumulated on the sea surface. Organic contaminants are more likely to accumulate on the sea surface due to their hydrophobic or surfactant properties. It has been reported that organic pollutants are present not only on the surface but also in ocean depths. Pollutants can be partitioned into the biota in the ocean and can accumulate overtime as a result. Essentially, the primary level of the food chain in the marine environment is composed of biomasses such as brown algae. These biomasses can be contaminated with organic pollutants which in turn bioaccumulate by organisms at the higher level of the food chain.

Natural polysaccharides, such alginate and chitin, are widely used in the pharmaceutical, food, cosmetic, and general manufacturing industries, and are valuable for applications in drug delivery systems as well as for anchoring and releasing active ingredients in various products. Moreover, these materials are highly compatible with environmental monitoring systems, to track pollutant distribution. Several studies over the last few decades have examined the physical properties, chemical composition, and exchange processes of the sea-surface microlayer at the air-sea interface. These studies have shown that a wide variety of xenobiotics accumulate on the sea surface, with organic contaminants in particular tending to concentrate there due to their hydrophobic or surfactant properties. Notably, these organic pollutants are present not only on the surface but also in deeper ocean layers, where they can partition into marine biota and accumulate over time. The primary level of the marine food chain is largely composed of biomasses such as brown algae, which can be contaminated with organic pollutants that bioaccumulate in higher-level organisms. Accordingly, monitoring pollutant accumulation at the lower levels of the food chain is important for understanding overall pollutant loads.

There remains a need in the art for new and improved methods to immobilize natural polysaccharides on solid surfaces, microextraction apparatuses, and methods to monitor partitioning of small organic molecules and predict accumulation behavior.

### SUMMARY

Provided herein is a microextraction apparatus comprising a substrate, an anchoring material directly on the substrate, and an adsorption material attached to the anchoring material, wherein the adsorption material comprises a polysaccharide.

In certain embodiments, the anchoring material comprises a polyphenol. In particular embodiments, the polyphenol is crosslinked. In particular embodiments, the polyphenol is crosslinked with cations. In particular embodiments, the cations are Ca²⁺ ions.

In certain embodiments, the anchoring material comprises tannic acid.

In certain embodiments, the substrate comprises a metallic material. In particular embodiments, the metallic material is stainless steel.

In certain embodiments, the polysaccharide is crosslinked. In particular embodiments, the polysaccharide is crosslinked with cations. In particular embodiments, the cations are Ca²⁺ ions.

In certain embodiments, the polysaccharide comprises alginic acid, chitosan, or chitin.

In certain embodiments, the anchoring material comprises tannic acid, and the polysaccharide comprises alginic acid.

In certain embodiments, the substrate comprises a metallic material, the polysaccharide comprises alginic acid, chitin, or chitosan, and the anchoring material comprises tannic acid. In particular embodiments, the metallic material is stainless steel.

In certain embodiments, the adsorption material comprises a first adsorption layer disposed on the substrate and a second adsorption layer disposed on the first adsorption layer. In particular embodiments, the first adsorption layer comprises a first crosslinked polysaccharide, and the second adsorption layer comprises a second crosslinked polysaccharide. In particular embodiments, the first crosslinked polysaccharide comprises chitosan, and the second crosslinked polysaccharide comprises chitin. In particular embodiments, the adsorption material further comprises a third adsorption layer disposed on the second adsorption layer. In particular embodiments, the first adsorption layer, the second adsorption layer, and the third adsorption layer are oven dried. In particular embodiments, the adsorption material further comprises a fourth adsorption layer disposed on the third adsorption layer, a fifth adsorption layer disposed on the fourth adsorption layer, and a sixth adsorption layer disposed on the fifth adsorption layer.

In certain embodiments, the anchoring material comprises a crosslinked polyphenol, and the polysaccharide is crosslinked. In particular embodiments, one or both of the crosslinked polyphenol and the crosslinked polysaccharide is crosslinked with Ca²⁺ ions. In particular embodiments, the substrate comprises stainless steel, the crosslinked polysaccharide comprises alginic acid, chitin, or chitosan, and the crosslinked polyphenol comprises tannic acid. In particular embodiments, the adsorption material comprises a first adsorption layer comprising a first crosslinked polysaccharide, and a second adsorption layer comprising a second crosslinked polysaccharide. In particular embodiments, the first crosslinked polysaccharide comprises chitosan, and the second crosslinked polysaccharide comprises chitin. In particular embodiments, the adsorption material further comprises a third adsorption layer disposed on the second adsorption layer. In particular embodiments, the adsorption material further comprises a fourth adsorption layer disposed on the third adsorption layer, a fifth adsorption layer disposed on the fourth adsorption layer, and a sixth adsorption layer disposed on the fifth adsorption layer.

Further provided is a method of assembling a microextraction apparatus, the method comprising depositing an anchoring material on a surface of a substrate to functionalize the surface, wherein the anchoring material comprises a polyphenol, and depositing an adsorption material on the anchoring material, wherein the adsorption material comprises a polysaccharide.

In certain embodiments, the method further comprises etching the surface prior to functionalizing the surface.

In certain embodiments, the method further comprises crosslinking the polyphenol prior to depositing the adsorption material on the anchoring material.

In certain embodiments, the method further comprises crosslinking the polysaccharide.

In certain embodiments, the polysaccharide comprises alginic acid, chitin, or chitosan.

In certain embodiments, the polyphenol comprises tannic acid.

In certain embodiments, the method further comprises at least one of (i) crosslinking the polyphenol prior to depositing the adsorption material on the anchoring material, and (ii) crosslinking the polysaccharide; and wherein one or both of the polyphenol and the polysaccharide is crosslinked by adding CaCl₂) or calcium tannate.

In certain embodiments, the substrate comprises a metallic material. In particular embodiments, the metallic material is stainless steel.

In certain embodiments, the substrate comprises a metallic material, the polyphenol comprises tannic acid, and the polysaccharide comprises alginic acid, chitin, or chitosan.

In certain embodiments, the step of depositing the adsorption material comprises depositing a first adsorption layer, and depositing a second adsorption layer on the first adsorption layer, wherein the first adsorption layer comprises chitosan and the second adsorption layer comprises chitin. In particular embodiments, the method further comprises depositing a third adsorption layer on the second adsorption layer, depositing a fourth adsorption layer on the third adsorption layer, depositing a fifth adsorption layer on the fourth adsorption layer, and depositing a sixth adsorption layer on the fifth adsorption layer. In particular embodiments, the method further comprises oven drying one or more of the first adsorption layer, the second adsorption layer, the third adsorption layer, the fourth adsorption layer, or the fifth adsorption layer.

In certain embodiments, the method further comprises storing the microextraction apparatus in a CaCl₂) solution.

In certain embodiments, the method further comprises drying the adsorption material at a temperature in the range of from about 60° C. to about 80° C.

Further provided is a method of extracting an analyte, the method comprising contacting a microextraction apparatus with a sample comprising an analyte, wherein the microextraction apparatus includes a substrate and an adsorption material disposed on the substrate, the adsorption material comprising a crosslinked polysaccharide; and adsorbing the analyte from the sample into the adsorption material. In particular embodiments, the method further comprises contacting the microextraction apparatus with a desorption solution and desorbing the analyte from the adsorption material to the desorption solution. In particular embodiments, the desorption solution comprises methanol, acetonitrile, water, or a combination thereof. In particular embodiments, the microextraction apparatus further comprises an anchoring material disposed between the substrate and the adsorption material, wherein the anchoring material comprises a crosslinked polyphenol. In particular embodiments, the crosslinked polyphenol comprises tannic acid. In particular embodiments, the crosslinked polyphenol is crosslinked with Ca²⁺ ions. In particular embodiments, the substrate comprises stainless steel. In particular embodiments, the crosslinked polysaccharide comprises alginic acid, chitin, or chitosan. In particular embodiments, the crosslinked polysaccharide is crosslinked with Ca²⁺ ions. In particular embodiments, the adsorption material comprises a first adsorption layer disposed on the substrate and a second adsorption layer disposed on the first adsorption layer. In particular embodiments, the first adsorption layer comprises a first crosslinked polysaccharide, and the second adsorption layer comprises a second crosslinked polysaccharide. In particular embodiments, the first crosslinked polysaccharide comprises chitosan, and the second crosslinked polysaccharide comprises chitin. In particular embodiments, the adsorption material further comprises a third adsorption layer disposed on the second adsorption layer, a fourth adsorption layer disposed on the third adsorption layer, a fifth adsorption layer disposed on the fourth adsorption layer, and a sixth adsorption layer disposed on the fifth adsorption layer.

In certain embodiments, the method further comprises removing the microextraction apparatus from a CaCl₂ solution prior to contacting the microextraction apparatus with the sample.

Further provided is a system for storing a microextraction apparatus, the system comprising a microextraction apparatus comprising a substrate, an anchoring material directly on the substrate, and an adsorption material attached to the anchoring material, wherein the adsorption material comprises a polysaccharide; and a storage container comprising a CaCl₂ solution, the storage container being configured to store the microextraction apparatus.

Advantageously, the microextraction apparatus and methods described herein which incorporate alginic acid can detect xenobiotic contamination or partition into a biomass, such as brown algae, which are found at lower levels in the food chain. The microextraction apparatus can mimic the structure of the outer cell wall amorphous embedded matrix of brown algae, which contains high levels of alginic acid. The microextraction apparatus and methods described herein which incorporate chitin can detect xenobiotic contamination or partition into a biomass, such as the exoskeletons of crustaceans, insects, and the cell walls of fungi.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1: Schematic of a microextraction apparatus, according to some embodiments of the disclosure.

FIG. 2: Schematic of a microextraction apparatus, according to some embodiments of the disclosure.

FIG. 3: Schematic of a microextraction apparatus, according to some embodiments of the disclosure.

FIG. 4: Schematic of a microextraction apparatus, according to some embodiments of the disclosure.

FIG. 5: Schematic of a microextraction apparatus, according to some embodiments of the disclosure.

FIG. 6: Illustration showing a microextraction apparatus disposed within a solution comprising analytes. The analytes are being adsorbed onto an adsorption material of the microextraction apparatus.

FIG. 7: Illustration showing a microextraction apparatus disposed within a desorption solution. The analytes are being desorbed from the adsorption material into the desorption solution.

FIG. 8: Illustration showing the cell wall structure of brown algae.

FIG. 9A: Table showing physico-chemical properties of selected pesticides and pharmaceuticals and their therapeutic uses/health effects making them useful targeted analytes.

FIG. 9B: Table showing physico-chemical properties of selected pesticides and pharmaceuticals and their therapeutic uses/health effects making them useful targeted analytes.

FIG. 10: Table showing compound-dependent parameters for triple quadruple mass spectrometry analysis of pharmaceuticals and pesticides.

FIG. 11: Table showing Q-Sight 220 instrument settings.

FIG. 12: Table showing mobile phase elution gradient for the developed LC-MS/MS method. Mobile phase A was 95:5 (v:v) water/methanol (containing 0.1% formic acid and 2 mM ammonium acetate) and B was 95:5 (v:v) methanol/water (containing 0.1% formic acid/2 mM ammonium acetate).

FIG. 13A: Microscopic image of a coated blade before the coated blade was immersed in ultra-pure water for 48 hr.

FIG. 13B: Microscopic image of a coated blade before the coated blade was immersed in ultra-pure water for 48 hr.

FIG. 14A: Microscopic image of the coated blade after the coated blade was immersed in ultra-pure water for 48 hr.

FIG. 14B: Microscopic image of the coated blade after the coated blade was immersed in ultra-pure water for 48 hr.

FIG. 15A: SEM image of a HCl treated blade surface before coating with tannic acid.

FIG. 15B: SEM images of a HCl treated blade surface after coating with tannic acid.

FIG. 16: A schematic representation of the process of applying the first layer of alginic coating on the stainless-steel substrate. Specifically, tannic acid is shown anchoring to stainless steel substrates, chelation of Ca²⁺ ions, and interacting with alginic acid through Ca²⁺ ions chelation.

FIG. 17A: Microscopic image of a wet alginic acid coated blade prepared using the coating technique described herein before immersion (40× magnification).

FIG. 17B: Microscopic images of a wet alginic acid coated blade prepared using the coating technique described herein before immersion (40× magnification).

FIG. 18A: Microscopic image of the wet alginic acid coated blade prepared using the coating technique described herein after immersion for one week in water (40× magnification).

FIG. 18B: Microscopic image of the wet alginic acid coated blade prepared using the coating technique described herein after immersion for one week in water (40× magnification).

FIG. 19A: Microscopic image of the wet alginic acid coated blade prepared using the coating technique described herein after immersion for one week in a mixture of MeOH:ACN (v:v) 1:1 (40× magnification).

FIG. 19B: Microscopic image of the wet alginic acid coated blade prepared using the coating technique described herein after immersion for one week in a mixture of MeOH:ACN (v:v) 1:1 (40× magnification).

FIG. 20A: Microscopic image of a dry alginic acid coated blade before immersion (40× magnification).

FIG. 20B: Microscopic image of the dry alginic acid coated blade after immersion in water (40× magnification).

FIG. 20C: Microscopic image of the dry alginic acid coated blade after immersion in a mixture of MeOH:ACN (v:v) 1:1 (40× magnification).

FIG. 21: Graph showing the amount of analytes desorbed from the dry and wet alginic acid coated blades during a first desorption.

FIG. 22: Graph showing the amount of analytes desorbed from the dry and wet alginic acid coated blades during a second desorption.

FIG. 23: Table showing analyte carryover percent % for dry and wet alginic acid coated blades.

FIG. 24: Table showing absolute recovery percentage % of analytes calculated using the amount of analyte desorb after six consecutive desorption steps. Analytes were extracted from 1.5 mL of mixture containing pesticides at 500 μg L⁻¹ and pharmaceuticals at 200 μg L⁻¹.

FIG. 25: Graph showing the amount of analytes extracted using the wet alginic acid coating made with and without priming the stainless steel with the tannic acid. (*—The results of a two-tailed t-test showed that the response for analytes from both tests are not statistically different from one another).

FIG. 26: Graph showing the amount of analytes desorb from the wet alginic acid coated blade to desorption solutions at different pH levels.

FIG. 27: Graph showing the percentage of analyte carryover in the coating during the desorption in each pH level of the desorption solutions.

FIG. 28: Table showing estimated partition coefficients (Kfs) of analytes to dry and wet alginic acid coating, wherein n is the number of adsorption layers.

FIG. 29A: Graph showing the amount of analytes desorb from the different numbers of layers (single layer, double layer, triple layer coatings) of a dry alginic acid coated blade.

FIG. 29B: Graph showing the amount of analytes desorb from the different numbers of layers (single layer, double layer, triple layer coatings) of a wet alginic acid coated blade.

FIG. 30A: Graph showing the amount of analytes extracted from sea water using the different numbers of layers (single layer, double layer, triple layer coatings) of dry alginic acid coated blade.

FIG. 30B: Graph showing the amount of analytes extracted from sea water using the different numbers of layers (single layer, double layer, triple layer coatings) of wet alginic acid coated blade.

FIG. 31: Graph showing comparison of amount of analytes extracted from ultrapure water and sea water using triple layer alginic acid coating.

FIG. 32: A schematic representation of the interaction between tannic acid, Ca²⁺ ions, and chitosan.

FIG. 33: Illustration of a method for creating chitosan-based microextraction apparatuses, according to some embodiments of the disclosure.

FIG. 34: Microscopic image of a chitosan coated blade.

FIG. 35: Microscopic image of a chitosan coated blade.

FIG. 36: Illustration of a method for creating chitin-based microextraction apparatuses, according to some embodiments of the disclosure.

FIG. 37: Microscopic image of a chitin coated blade.

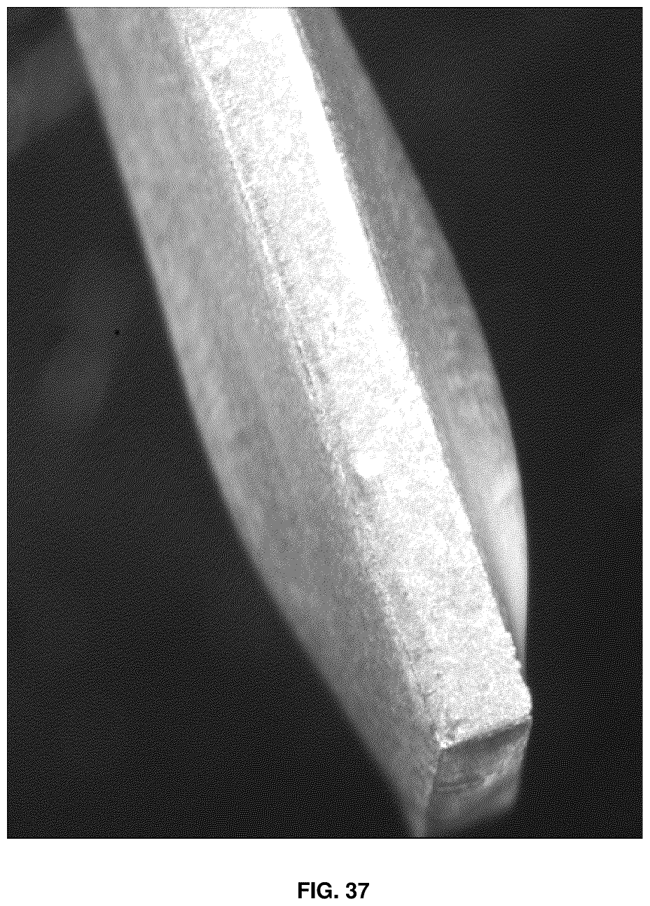

FIG. 38: Microscopic image of a triple layer chitin coated blade.

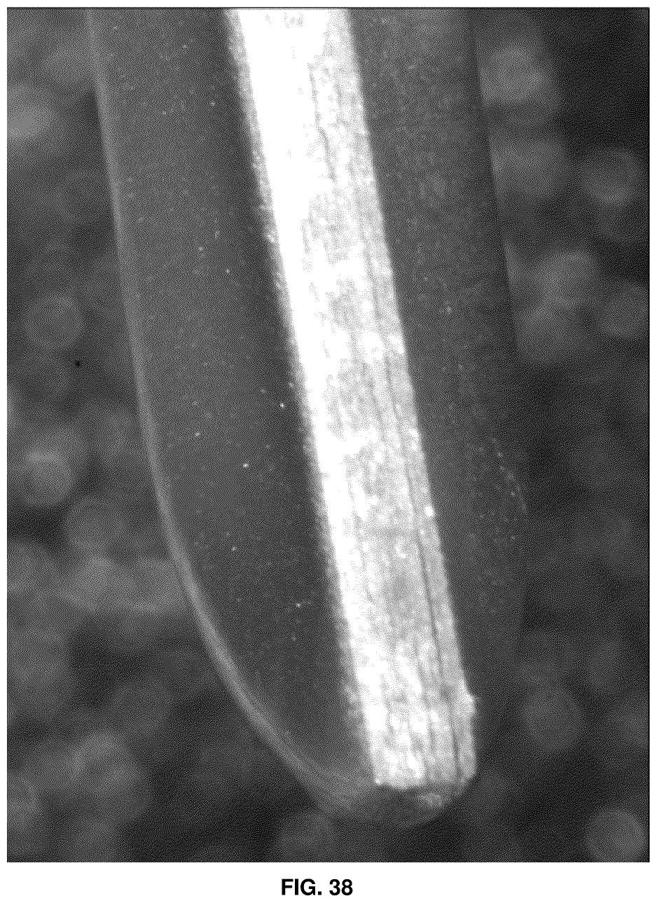

FIG. 39: Microscopic image of a triple layer etched chitin coated blade.

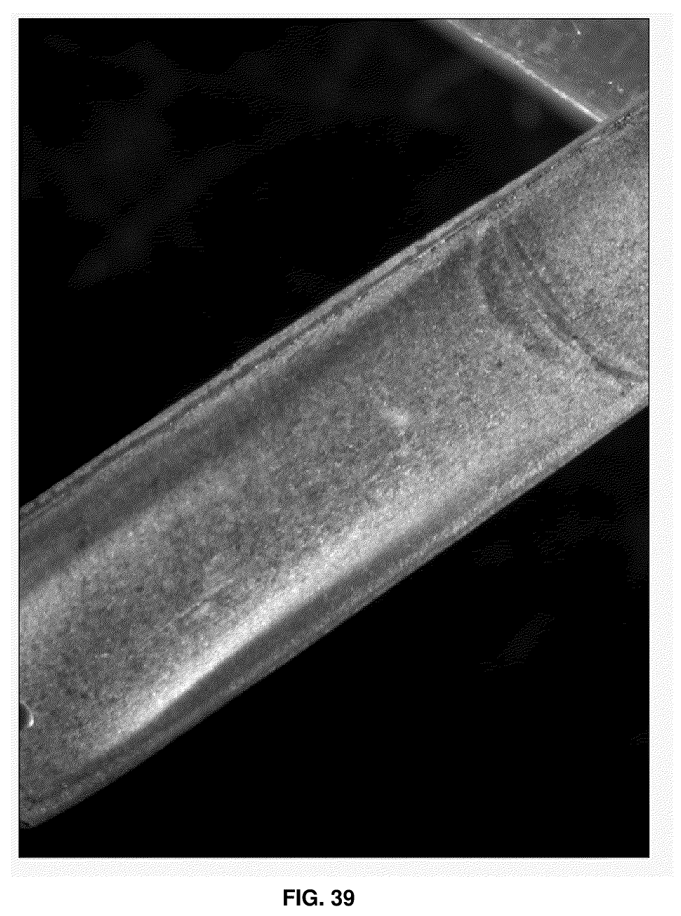

### DETAILED DESCRIPTION

Throughout this disclosure, various publications, patents, and published patent specifications are referenced by an identifying citation. The disclosures of these publications, patents, and published patent specifications are hereby incorporated by reference into the present disclosure in their entirety to more fully describe the state of the art to which this invention pertains.

As used herein, the term “material” can include a substance having one or more constituents or components.

To date, strategies to perform partition studies of small molecules do not closely mimic biomasses. It is also difficult to preconcentrate molecules unless substantial chemical modifications are applied to the biomass. Provided here are coating methods to create microextraction apparatuses, and microextraction apparatuses which can mimic biomasses to investigate portioning of micropollutants or active ingredients. In accordance with the present disclosure, a polysaccharide-containing coating can be used on a substrate to create an apparatus for preconcentration of micropollutants.

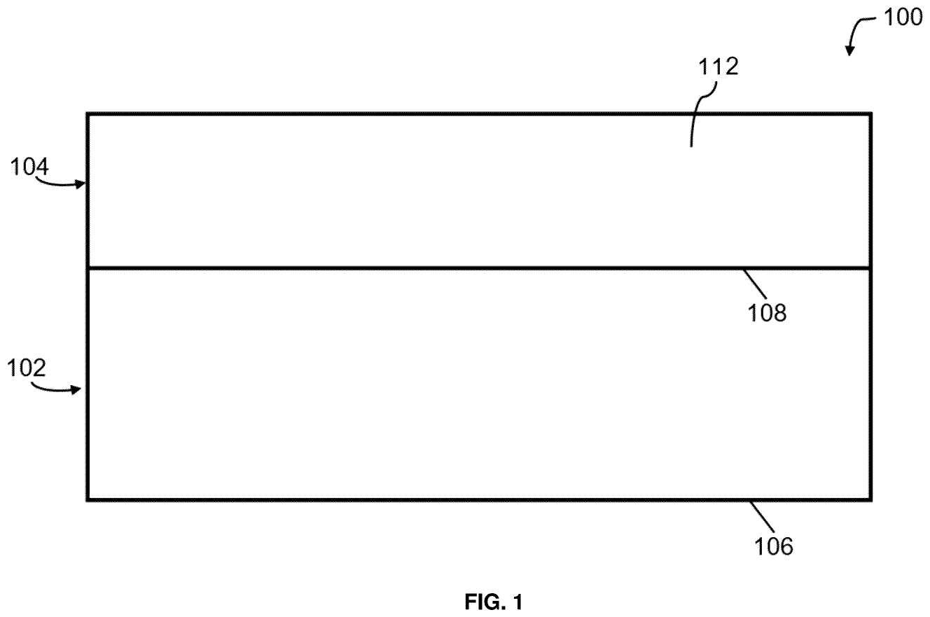

With collective reference to FIGS. 1-5, a microextraction apparatus 100 can include a substrate 102 and an adsorption material 104. The substrate 102 can include a first surface 106 and a second surface 108. The substrate 102 is adapted to support the adsorption material 104. In certain examples, the substrate 102 comprises a metallic material, a composite material, a polymer, glass, a plastic material, or a combination thereof. Examples of metallic materials include, but are not limited to, stainless steel, aluminum, copper, bronze, brass, galvanized steel, or a combination thereof. In certain examples, the substrate 102 is 3D printed. The substrate 102 may also include other materials, including materials that facilitate being substantially water resistant and facilitate being substantially bound to the adsorption material 104. In certain examples, the substrate 102 is a blade. Desirably, the substrate 102 can be recyclable. In certain embodiments, the substrate 102 can be substantially annular. However, one skilled in the art can employ other shapes for the substrate 102 within the scope of this disclosure.

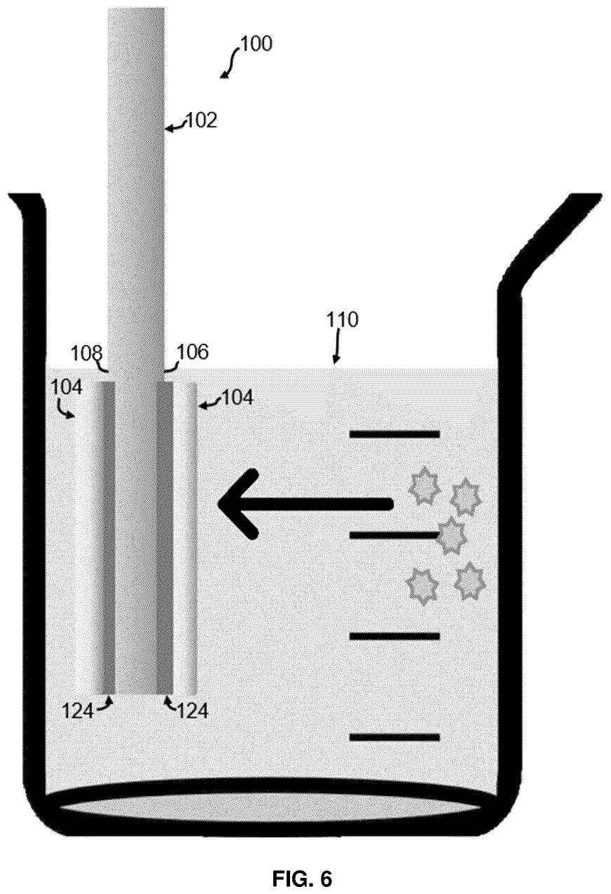

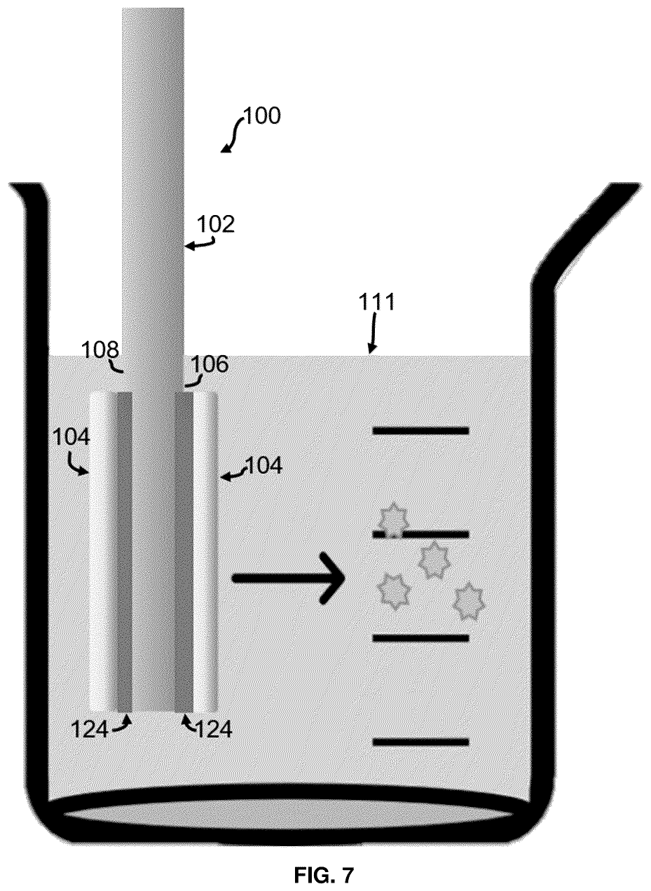

While still referring to FIGS. 1-5, the adsorption material 104 is disposed on the substrate 102, either directly or with one or more intervening materials therebetween. As shown in FIGS. 6-7, the adsorption material 104 can be disposed on the first surface 106, the second surface 108, or both the first surface 106 and the second surface 108 of the substrate 102. The adsorption material 104 may also substantially or partially encircle or surround the substrate 102. Different methods may be employed to dispose the adsorption material 104 onto the substrate 102, either directly or with one or more intervening materials therebetween. Suitable examples include, but are not limited to, dip coating, spin coating, electrospun coating, spray coating, or roll coating. Depending on the desired amount of the adsorption material 104, the substrate 102 may be fully or partially immersed in the absorption material 104.

The adsorption material 104 is configured to adsorb chemicals, such as analytes, from a sample 110 where the chemicals are present, such as in a body of water (including fresh water or salt water), a coating of a biomedical device, cosmetics, drugs, or marine plants. Once the chemicals are adsorbed onto the adsorption material 104, the chemicals can then be desorbed from the adsorption material 104 using a desorption solution 111, so that the chemicals can be further analyzed. The desorption solution 111 can be, for example, methanol, acetonitrile, water, or a combination thereof. Analytes can include, but are not limited to, common pollutants in water or pharmaceutical drugs, such as diazepam, lorazepam, coumaphos, cypermethrin, alprazolam, methaqualone, acetochlor, chlorpyrifos methyl, cyprodinil, or a combination thereof.

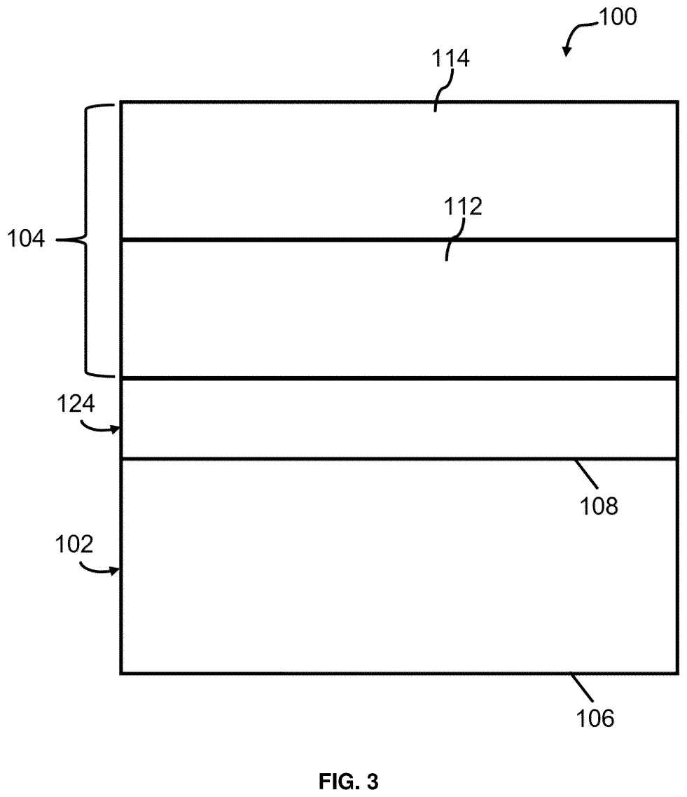

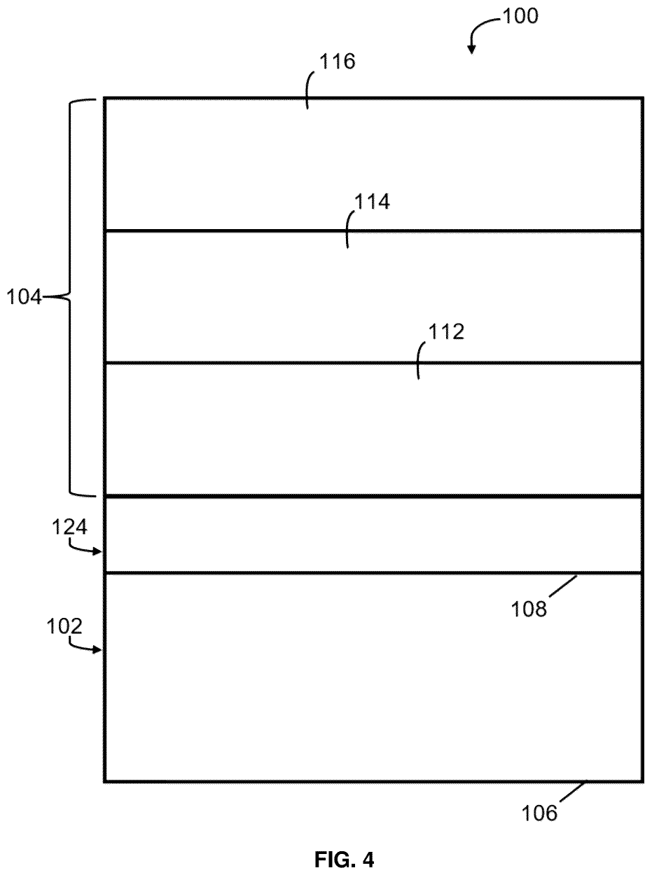

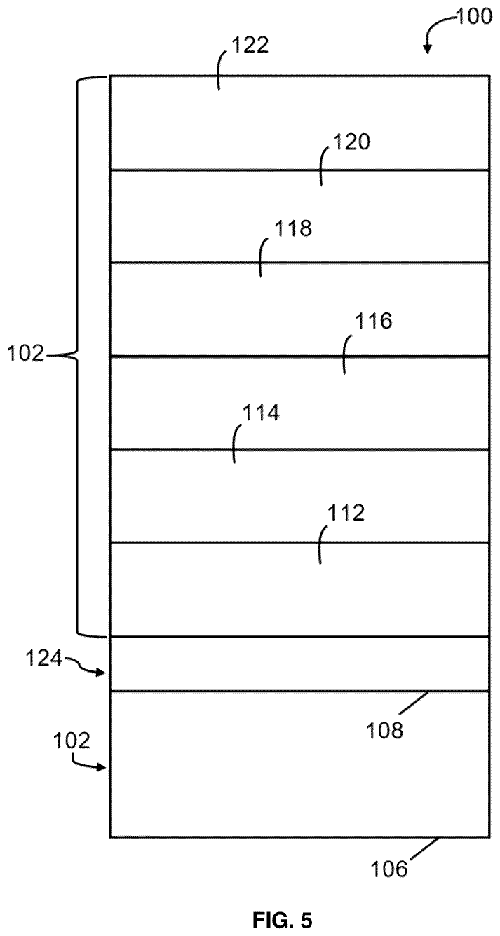

With reference to FIGS. 3-5, the adsorption material 104 can include one or more adsorption layers. For example, FIG. 3, shows the adsorption material 104 with a first adsorption layer 112 disposed on the substrate 102 and a second adsorption layer 114 disposed on the first adsorption layer 112. FIG. 4 shows the adsorption material 104 with the first adsorption layer 112, the second adsorption layer 114, and a third adsorption layer 116. FIG. 5 shows the adsorption material 104 with the first adsorption layer 112, the second adsorption layer 114, the third adsorption layer 116, a fourth adsorption layer 118 disposed on the third adsorption layer 116, a fifth adsorption layer 120 disposed on the fourth adsorption layer 118, and a sixth adsorption layer 122 disposed on the fifth adsorption layer 120. In certain embodiments, one or more adsorption layers are wet in the form of hydrogels. In certain embodiments, one or more of the adsorption layers can be dried in an oven or through other means. In on non-limiting example, the adsorption layers are oven dried for about 30 min at a temperature in the range of from about 60° C. to about 80° C. However, this is not strictly necessary. As described in more detail in the examples herein, it has been demonstrated that oven dried adsorption layers have a higher analyte-coating partition coefficient than non-oven dried adsorption layers. In addition, dried adsorption layers have demonstrated lower analyte carryover (<5% except for coumaphos) compared to non-dried adsorption layers, which ranged from 11%-19%.

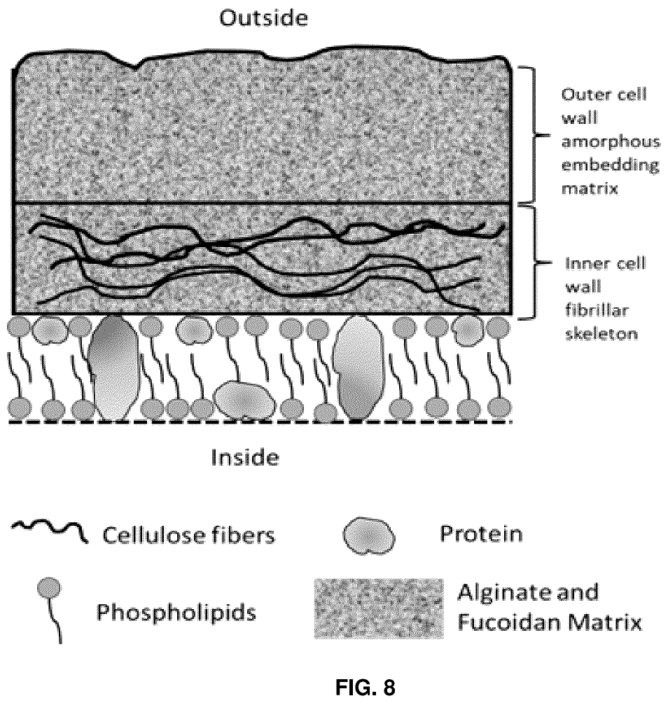

The adsorption material 104 can mimic the structure of a biomass such as, for example, the outer cell wall amorphous embedded matrix of brown algae shown in FIG. 8, which contains high levels of alginic acid. The adsorption material 104 can also mimic the structure of a biomass such as the exoskeletons of crustaceans, insects, and the cell walls of fungi, which contain chitin. Desirably, the adsorption material 104 can be biodegradable. The adsorption material 104 can include, or can consist entirely or substantially of, a polysaccharide. Polysaccharides are carbohydrates composed of chains of simple sugar units (monosaccharides) linked together through glycosidic bonds. In certain examples, the polysaccharide is alginic acid, chitosan, chitin, or a combination thereof. However, other polysaccharides are possible and encompassed within the scope of the present disclosure. In one non-limiting example, the adsorption material 104 is disposed on the substrate 102 by dip coating the substrate 102 in a 2.3% (w/v) alginic acid solution, a 2.0% (w/v) chitosan slurry, 1.6% (w/v) chitin slurry, or a combination thereof. However, other methods of depositing the adsorption material 104 on the substrate 102 are possible and encompassed within the scope of the present disclosure.

The polysaccharide can also be crosslinked with a first crosslinker, which may a source of cations (i.e., a salt). Although the crosslinker is described as being a salt, it is understood that the actual species accomplishing the crosslinking may be cations from the salt, such as Ca²⁺ ions. Advantageously, because Ca²⁺ ions can be used, the crosslinking can be accomplished under atmospheric conditions. Non-limiting examples of suitable salts include calcium chloride (CaCl₂)) and calcium tannate. However, other salts or other crosslinkers are possible and encompassed within the scope of the present disclosure. In embodiments including multiple adsorption layers, the first crosslinker can be used to crosslink the one or more adsorption layers with each other.

In certain examples, one of the adsorption layers which make up the adsorption material 104 can include a polysaccharide different from the polysaccharide in a subsequent adsorption layer. In other words, the adsorption material 104 may be composed of multiple layers of different polysaccharides. For example, the first adsorption layer 112 can include a chitosan as a first polysaccharide while at least one additional adsorption layer, e.g., the second adsorption layer 114, includes chitin as a second polysaccharide.

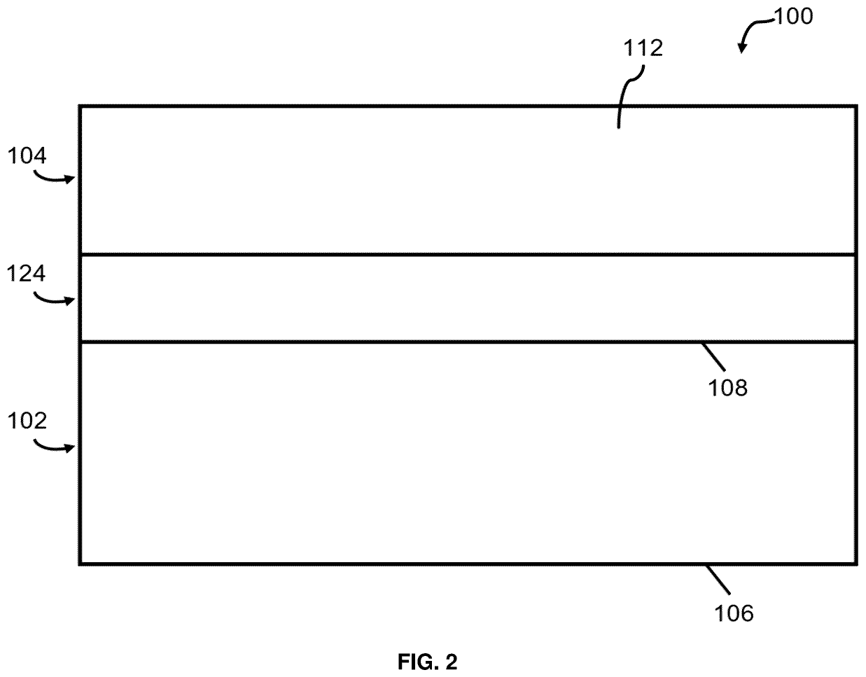

With reference to FIGS. 2-5, the microextraction apparatus 100 can further include an anchoring material 124. The anchoring material 124 can be disposed between the substrate 102 and the adsorption material 104. In particular, the anchoring material 124 may be disposed directly on the substrate 102. As shown in FIGS. 6-7, the anchoring material 124 can be disposed on the first surface 106, the second surface 108, or both the first surface 106 and the second surface 108 of the substrate 102. The anchoring material 124 may also substantially or partially encircle or surround the substrate 102. Different methods may be employed to dispose the anchoring material 124 onto the substrate 102. Suitable examples include, but are not limited to, dip coating, spray coating, or roll coating. Depending on the desired amount of the anchoring material 124, the substrate 102 may be fully or partially immersed in the anchoring material 124. However, other methods are possible and encompassed within the scope of the present disclosure.

The anchoring material 124 is configured to facilitate surface functionalization of the substrate 102 to enable, for example, the adsorption material 104 to adhere to the substrate 102. As will be described in further detail below, it has been found that the anchoring material 124 is especially advantageous in adhering the adsorption material 104 to the substrate 102 when the substrate 102 comprises stainless steel and the adsorption material 104 comprises alginic acid. The anchoring material 124 can include a polyphenol. Polyphenols are characterized by the presence of multiple phenolic (aromatic) rings in their chemical structure, typically including one or more hydroxyl groups attached to these aromatic rings. Non-limiting example polyphenols include tannic acid, resveratrol, quercetin, catechins, epicatechin, curcumin, anthocyanins, gallic acid, rutin, chlorogenic acid, or a combination thereof. In one non-limiting example, the anchoring material 124 is disposed on the substrate 102 by dip coating the substrate 102 in a solution of 0.7% (w/w) tannic acid.

In certain examples, the polyphenol is crosslinked with a second crosslinker. The anchoring material 124 can consist entirely or substantially of the polyphenol and the second crosslinker. The second crosslinker can be a source of cations (i.e., a salt). Although the crosslinker is described as being a salt, it is understood that the actual species accomplishing the crosslinking may be cations from the salt, such as Ca²⁺ ions. Advantageously, because Ca²⁺ ions can be used, the crosslinking can be accomplished under atmospheric conditions. Non-limiting examples of salts include calcium chloride (CaCl₂)) and calcium tannate. The second crosslinker can be used to crosslink the anchoring material 124 to the adsorption material 104. However, the presence of the second crosslinker is not strictly necessary, and embodiments which do not include the second crosslinker are encompassed within the scope of the present disclosure. Furthermore, second crosslinkers other than salts are possible and encompassed within the scope of the present disclosure.

A system for storing a microextraction apparatus 100 may include the microextraction apparatus 100 and a storage container. The storage container may include a CaCl₂ solution, and is configured to store the microextraction apparatus 100 prior to use or between uses.

A method of assembling the microextraction apparatus 100 can include disposing the adsorption material 104 on the substrate 102, where the adsorption material 104 includes a polysaccharide, and crosslinking the polysaccharide to form the apparatus shown in FIG. 1. In certain examples, the method includes disposing the anchoring material 124 on the substrate 102 prior to disposing the adsorption material 104 on the substrate 102, where the anchoring material 124 includes a polyphenol, to form the apparatus 100 shown in FIG. 2. The method can also include crosslinking the polyphenol prior to disposing the adsorption material 104 on the substrate 102.

The method can further include etching the substrate 102 prior to disposing the adsorption material 104 on the substrate 102 and/or prior to disposing the anchoring material 124 on the substrate 102. The etching can include sonicating the substrate 102 in a sonicating solution, optionally followed by a series of organic solvents. The sonicating solution can include hydrochloric acid (HCl). The organic solvents can include ultra-pure water, acetone, ethanol, or a combination thereof. The etching step can further include drying the substrate in an oven at a temperature in the range of from about 60° C. to about 80° C.

The method can further include a step of storing the substrate 102, after the deposition of the adsorption material 104 and/or the anchoring material 124, in a CaCl₂ solution until use of the microextraction device 100. The CaCl₂ solution can be, for example, a 9.5% (w/v) CaCl₂ solution.

The method can further include steps to apply additional adsorption layers. For example, the method can include the following steps: disposing the first adsorption layer 112 on the substrate 102; crosslinking the polysaccharide in the first adsorption layer 112; disposing the second adsorption layer 114 on the first adsorption layer 112; and crosslinking the polysaccharide in the second adsorption layer 114 to form the apparatus shown in FIG. 3.

In another example, the method can further include steps to apply additional adsorption layers. For example, the method can include the following steps: disposing the first adsorption layer 112 on the substrate 102; crosslinking the polysaccharide in the first adsorption layer 112; disposing the second adsorption layer 114 on the first adsorption layer 112; crosslinking the polysaccharide in the second adsorption layer 114; disposing a third adsorption layer 116 on the second adsorption layer 114; and crosslinking the polysaccharide in the third adsorption layer 116 to form the apparatus shown in FIG. 4. In other examples, some but not all of the polysaccharides in the adsorption layers 112, 114, 116 are crosslinked.

In another example, the method can further include steps to apply additional adsorption layers. For example, the method can include the following steps: disposing the first adsorption layer 112 on the substrate 102; crosslinking the polysaccharide in the first adsorption layer 112; disposing the second adsorption layer 114 on the first adsorption layer 112; crosslinking the polysaccharide in the second adsorption layer 114; disposing a third adsorption layer 116 on the second adsorption layer 114; crosslinking the polysaccharide in the third adsorption layer 116; disposing the fourth adsorption layer 118 on the third adsorption layer 116; crosslinking the polysaccharide in the fourth adsorption layer 118; disposing the fifth adsorption layer 120 on the fourth adsorption layer 118; crosslinking the polysaccharide in the fifth adsorption layer 120; disposing a sixth adsorption layer 122 on the fifth adsorption layer 120; and crosslinking the polysaccharide in the sixth adsorption layer 122 to form the apparatus shown in FIG. 5. In other examples, some but not all of the polysaccharides in the adsorption layers 112, 114, 116, 118, 120 are crosslinked.

The method can further include drying one or more adsorption layers 122. For example, the adsorption layers 122 may be oven dried for 30 minutes at 60-80° C. The method can include drying the first adsorption layer 112, the second adsorption layer 114, and/or the third adsorption layer 116, prior to depositing and crosslinking the fourth adsorption layer 118, the fifth adsorption layer 120, and the sixth adsorption layer 122.

The microextraction apparatus 100 is useful for extracting one or more analytes from a solution. Desirably, the microextraction apparatus 100 can be used as a testing device to extract analytes from a solution, such as sea water, to determine the pollutants in the seawater. Moreover, the microextraction apparatus 100 can mimic the structure of the outer cell wall amorphous embedded matrix of brown algae, which contains high levels of alginic acid. This can help determine the pollutants that the brown algae is absorbing/adsorbing in its environment. The microextraction apparatus 100 can also mimic the structure can of a biomass such as the exoskeletons of crustaceans, insects, and the cell walls of fungi, which contain chitin. This can help determine the pollutants that these animals are absorbing/adsorbing in their environment.

Referring now to FIG. 6, a method of extracting analytes can include contacting the microextraction apparatus 100 with a sample 110 containing analytes, and allowing analytes from the sample 110 to adsorb onto the adsorption material 104. As illustrated in FIG. 7, the method can further include contacting the microextraction apparatus 100 with a desorption solution 111, and allowing the analytes from the adsorption material 104 to desorb from the adsorption material 104 into the desorption solution 111. Desirably, the microextraction apparatus 100 can be used as a spot and/or passive sampler. In addition, the described apparatuses and methods can be used to calculate the partition of chemicals adsorbed in the adsorption material 104. This can be useful to establish bioaccumulation in marine plants. In addition, the adsorption material 104 can be used to adsorb and release drugs and to detect drug interactions with encapsulation excipients. Alginic acid is used as a coating for pharmaceuticals, and tannic acid has been shown to increase drug encapsulation efficiency and reduce drug burst release. In addition, the described apparatuses and methods can be used to test delivery of active ingredients in cosmetics (alginic acid is present in many cosmetic formulations).

Coatings involving the adsorption material 104 with or without the anchoring material 124 can be used to simulate plant-based marine biomass to measure the partition of organic pollutants from aqueous and gaseous media, or as a biocompatible extraction phase to avoid biological fouling during analytical extraction. The coatings can be used to measure the partition of environmental pollutants onto biomasses from aqueous and gaseous phases, which, in turn, provides important information about bioaccumulation and can serve as a preliminary screening of the sorption efficiency of water filters.

Coatings involving the adsorption material 104 with or without the anchoring material 124 can also be useful for coating biomedical devices. Alginic acid, for example, is biocompatible, antimicrobial, and used for wound dressing. The coatings are also useful for food packaging or as hydrophilic coatings for mechanical lubrication.

### EXAMPLES

### Example 1—Alginate Coatings

### Materials and Instrumentation

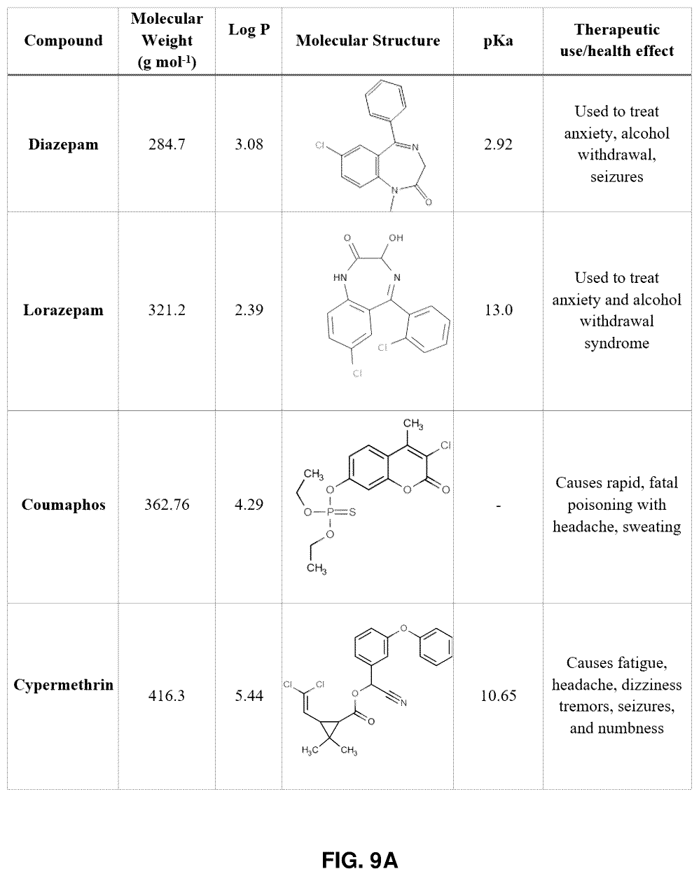

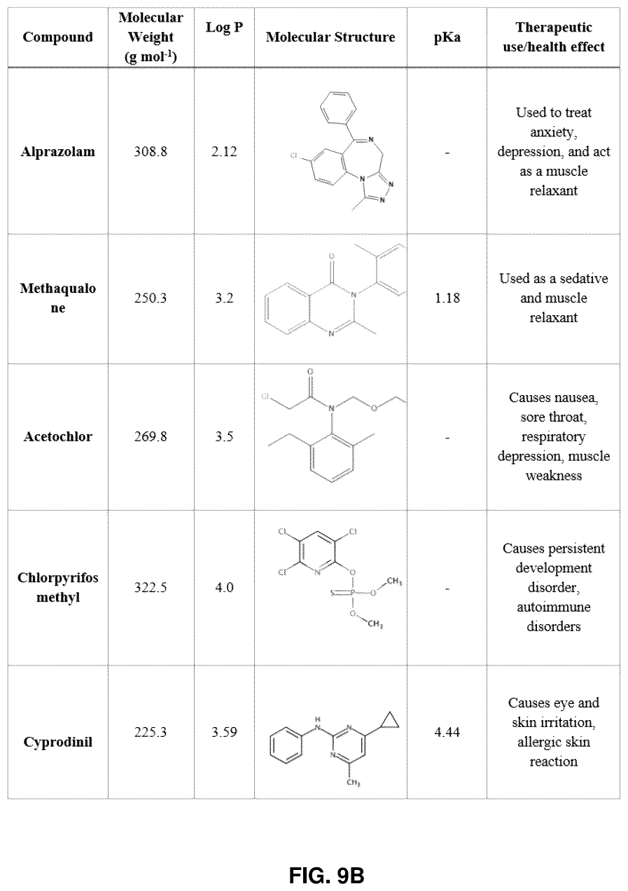

The reference standards of pesticides and sodium alginate were purchased from Sigma Aldrich (TX, USA) and pharmaceuticals were acquired from Cerilliant-Sigma Aldrich (Austin, TX, USA). The physical-chemical properties and molecular structure of the targeted analytes are summarized in FIGS. 9A-9B. All the solvents (methanol, water) and reagents (ammonium formate, formic acid) used were LC-MS grade and obtained from Fisher Scientific (Waltham, MA, USA). ACS grade tannic acid was purchased from Chem Center (CA, USA). Stainless steel blades were purchased from Yardley Manufacturing Co. (Toledo, OH).

### Instrumentation and Data Processing

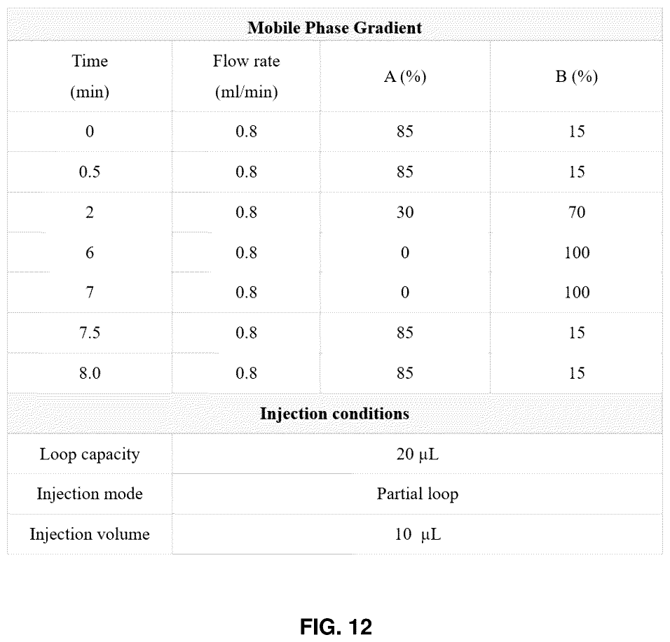

Chromatographic separation was carried out using a Perkin Elmer QSight® LX50 binary pump UHPLC, autosampler, and column compartment (PerkinElmer Inc., Waltham, MA, USA), at a column temperature of 30° C., using a 100 mm×4.6 mm C18 column 2.7 μm ((Restek Corporation, Bellefonte, PA, USA). The total run time was 8 minutes. Mobile phase A was 95:5 (v:v) water/methanol (containing 0.1% formic acid and 2 mM ammonium acetate) and mobile phase B was 95:5 (v:v) methanol/water (containing 0.1% formic acid/2 mM ammonium acetate). The injection conditions and the mobile phase gradient used are mentioned in FIG. 12.

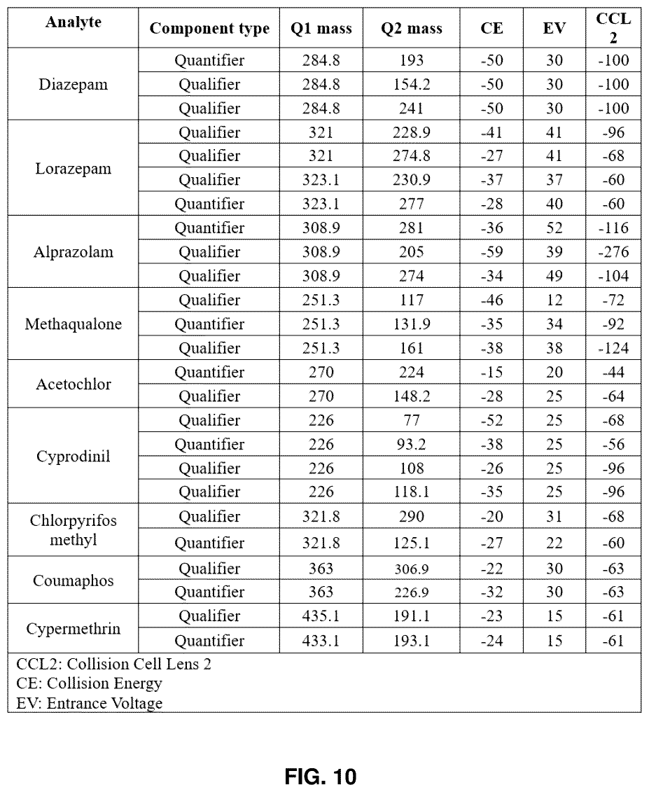

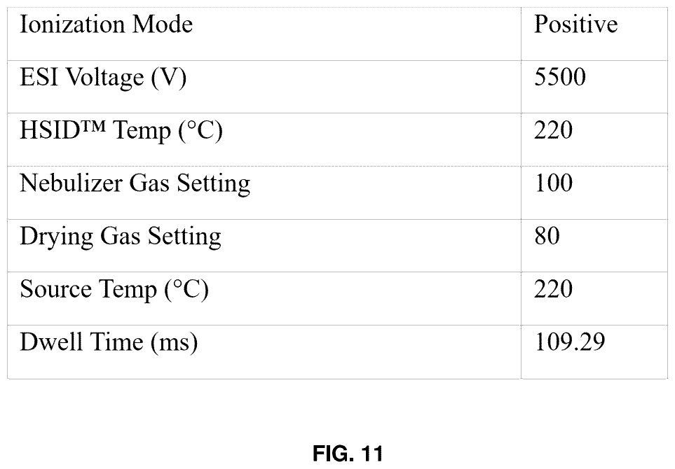

The analytes were detected using a triple quadrupole mass spectrometer Perkin Elmer QSight® 220 (PerkinElmer Inc. Waltham, MA, USA) with heated electrospray ionization in positive mode. All the analytes were monitored in the multiple reaction monitoring (MRM) mode. To produce the nitrogen gas flow for the ESI source, the laminar flow ion guide, and the collision cell, Parker/Balston nitrogen generator (Parker Hannifin Corporation, Lancaster, NY, USA) were used. FIG. 10 and FIG. 11 describe the operational conditions for mass spectrometry analysis.

For the analysis of data and method validation, Simplicity 3Q software (version 3.11142) (PerkinElmer Inc., Waltham, MA USA) was used, and Excel 2010 (Microsoft Corporation, Albuquerque, NM, USA) was used for statistical analysis. For each analyte, the mass transition with the highest response was used as a quantifier, while other mass transitions were kept as qualifiers. The amounts of analytes extracted by the SPME device, expressed in ng, were calculated by calibrating the instrument with standard solutions of the targeted analytes.

### Preparation of Alginic Acid and Tannic Acid Solution

To prepare 2.3% (w/w) alginic acid solution, 0.2354 g of alginic acid was added to a 20 mL vial containing 10 g of ultrapure water and a stir bar. The vial was then capped, parafilmed to prevent loss of water, and allowed to stir using a magnetic stirrer at 1200 rpm. When the alginic acid was completely dissolved, the vial was sonicated until all residual air bubbles were removed. Alginic acid solution was stored in the refrigerator until use. In order to prepare a 0.7% (w/w) tannic acid solution, 0.27 g of tannic acid was dissolved in 40 mL of 0.6 mol L⁻¹ NaCl solution.

### Procedure for Etching and Priming of the Stainless-Steel Blade Surface

In order to etch the stainless-steel surface, blades were sonicated in 36% (w/w) hydrochloric acid (HCl) solution for 12 min. The blades were then sonicated for 10 min in the ultra-pure water, acetone, and ethanol solutions, sequentially. Finally, the blades were dried at 70-80° C. in a laboratory oven. In order to prime the stainless-steel blade, 1.2 mL of 0.7% (w/w) tannic acid solution was added to a 2 mL vial, and the blade was inserted into the vial via a slit cut into the vial cap. The vial was then agitated at 1000 rpm for 12 hours.

Procedure for Coating Stainless-Steel Blades with Alginic Acid

Blades were removed from the tannic acid solution and placed into a 9.5% (w/v) CaCl₂ solution for 30 seconds to create the interaction between Ca²⁺ ions and tannic acid on the blade. Next, blades were placed in a vial with ultra-pure water and swirled vigorously for 10 s to remove any additional salt from the blade surface. After that, the blades were air-dried. The blade was coated using the dip coating method as follows: the blade was held straight in the upright position and gently dipped in the 2.3% (w/v) alginic acid solution. To prevent uneven coatings, the blade was removed slowly and incrementally from the alginic acid solution. Upon removing the blade from the alginic acid solution, the blade was dipped into the solution of 9.5% (w/v) CaCl₂ for 1 min and 30 s to facilitate the Ca²⁺ ion crosslinking of the outer surface of the alginic acid layer. Excess Ca²⁺ ions were removed from the coating by washing it with ultra-pure water for 10 s. The described process was repeated three times to achieve three layers of alginic acid coating on the blade surface. These coated blades were labeled as ‘wet alginic acid coated blades’ and stored in 9.5% (w/v) CaCl₂) until further use.

In order to prepare an oven dried blade coating (alginic acid coated dry blades), three layers of alginic acid were coated following the procedure described above and the coated blade was dried in an oven for 30 min at 80° C. Again, another three layers of alginic acid were applied on top of the dried coating prior to being dried in the oven. Alginic acid coated dry blades were also stored in 9.5% (w/v) CaCl₂) until further use.

### SPME Extraction and Desorption Procedure

An analyte solution containing pharmaceuticals and pesticides was prepared using ultrapure water. In the analyte solution, final concentrations of the pharmaceuticals and pesticides were at 2 mg L⁻¹ and 5 mg L⁻¹, respectively. Analytes used in this example are listed in FIG. 9A and FIG. 9B. The total amount of organic content in the analyte solution was maintained at <1%. Both blades with wet and dried coatings were used for the extraction experiments. Blades were rinsed for 10 s with ultrapure water in order to remove the additional CaCl₂ from the surface of the coating. For analyte extraction, blades were immersed in a 2 mL vial containing 1.5 mL of aqueous analytes solution and agitated for 6 hours at 1000 rpm.

In order to desorb the analytes from the coating, blades were desorbed in a vial with an insert containing 400 μL of desorption solution of methanol, acetonitrile, and water into the volume ratio of 2:2:1 for 6 hours at 250 rpm agitation. After desorption, each vial was analyzed using LC-MS/MS.

### Estimation of Partition Coefficient Using SPME

The analyte-coating partition coefficient (Kfs) can be calculated using the following equation 1:

$${K}_{f s} = {V}_{s} / ( {V}_{f} [ ( {n}_{o} / {n}_{f} ) - 1 ] ) \qquad ( 1 )$$

where n₀ is the initial amount of analyte in the sample and Vs is the volume of the sample, which was maintained at 1.5 mL in this example. V_{f} is the volume of the sorbent that was estimated based on the film thickness and the length of the coating. By using response factors generated from external calibration curves, the amount of analyte partitioned into coating (n_{f}) at equilibrium is calculated. External calibration curve of the analyte peak areas versus the amount of the analyte injected (ng) onto the LC column were generated by injecting 10 μL of standard mixtures ranging from 0.2 μg L⁻¹ to 250 μg L⁻¹.

### Preparation and Characterization of Solid Phase Microextraction Blades

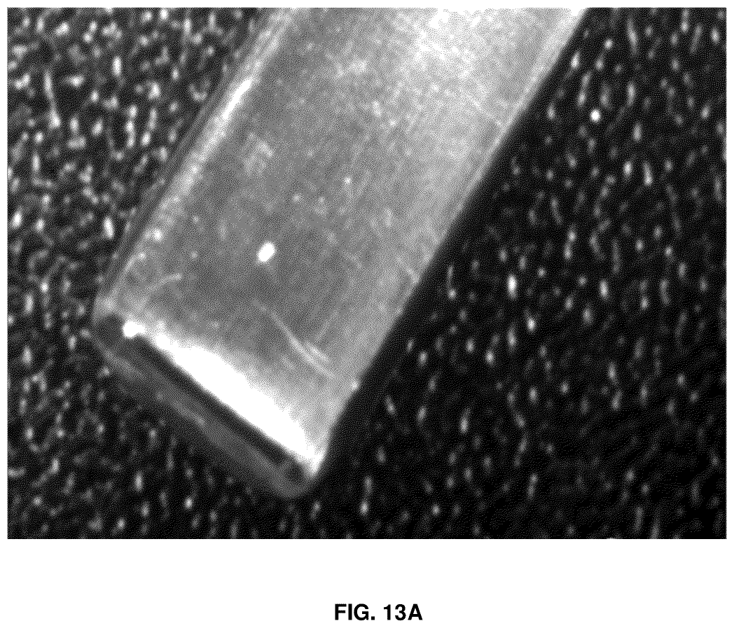

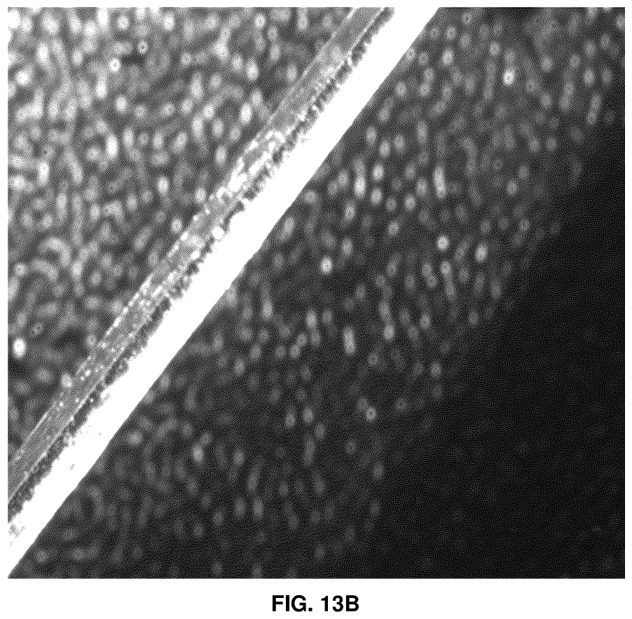

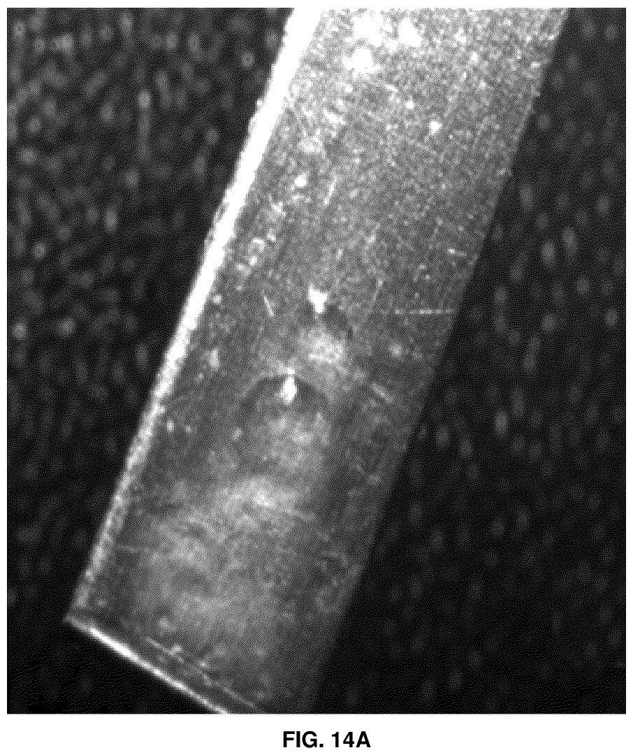

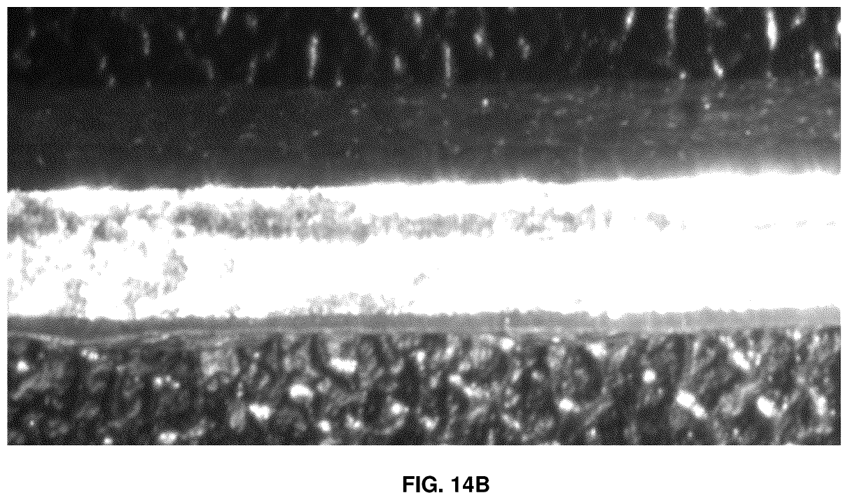

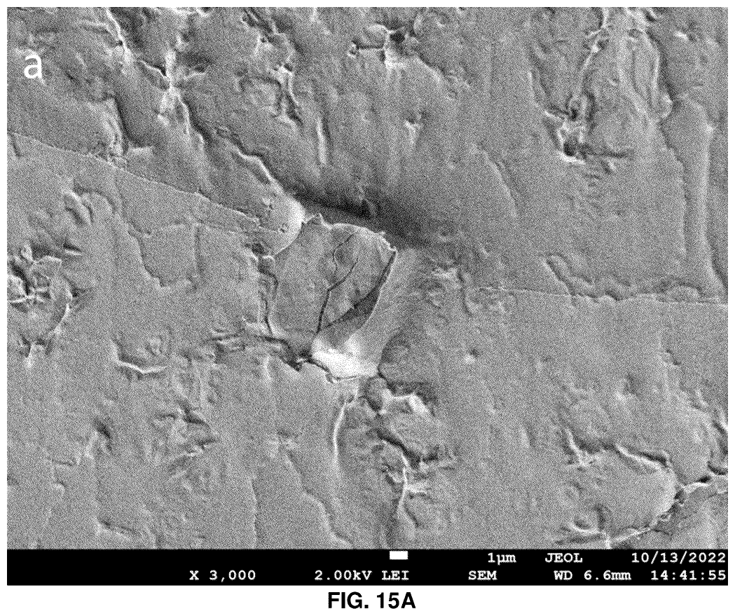

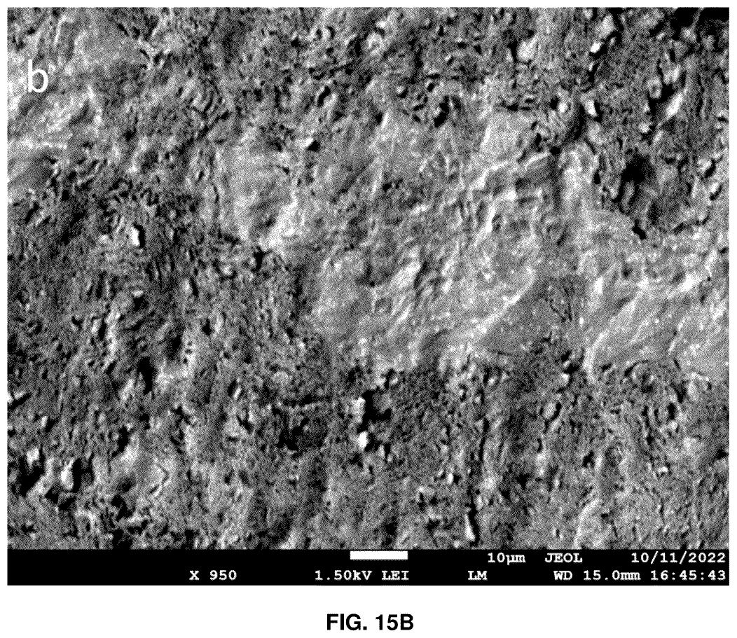

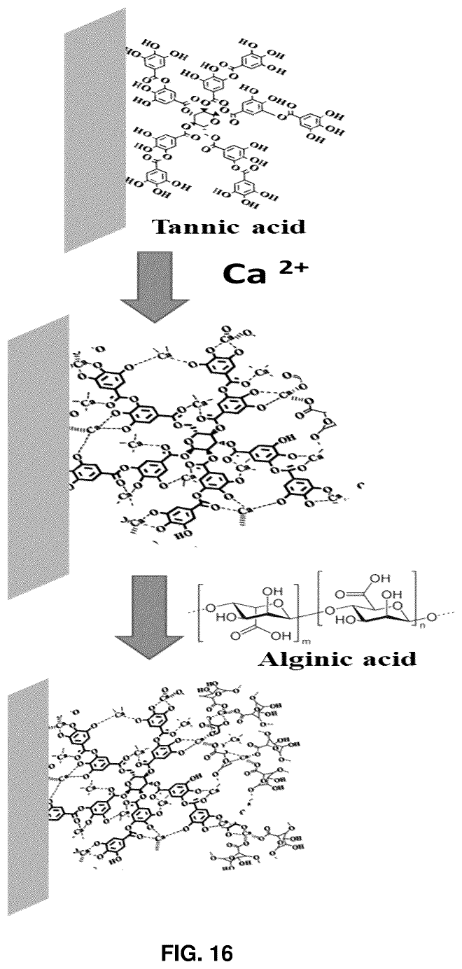

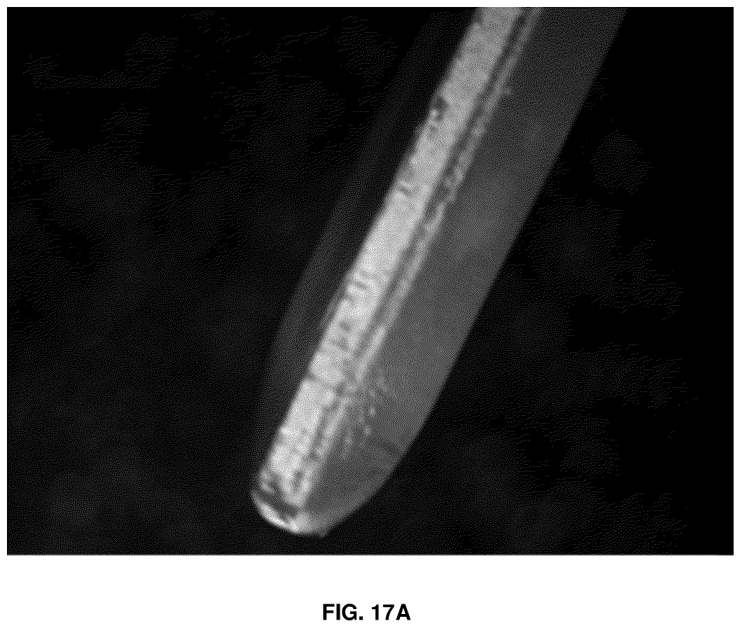

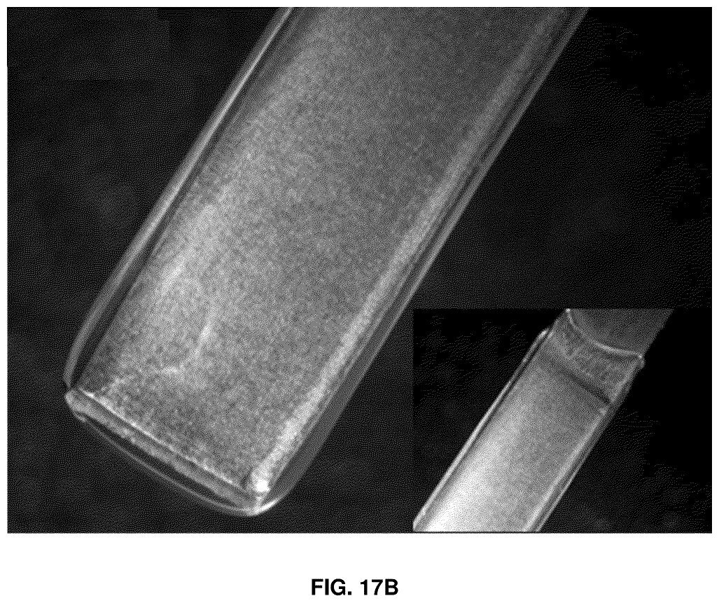

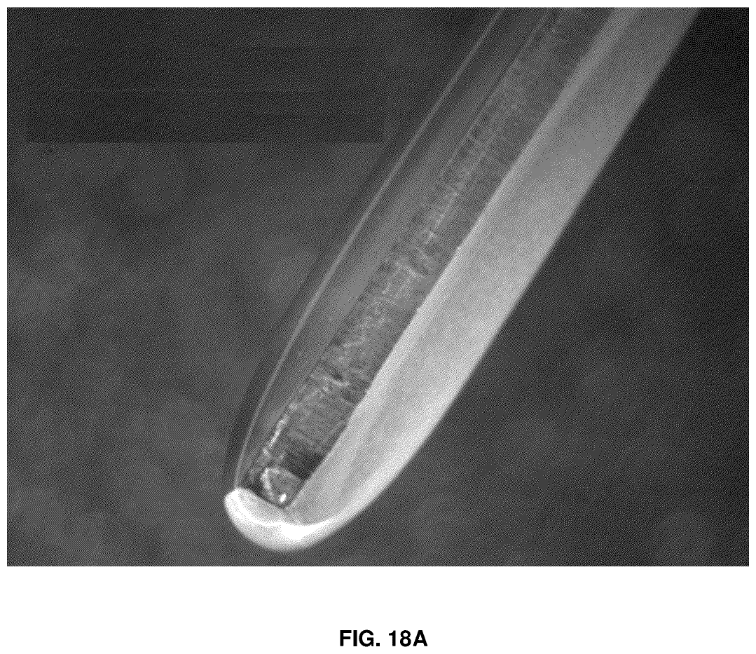

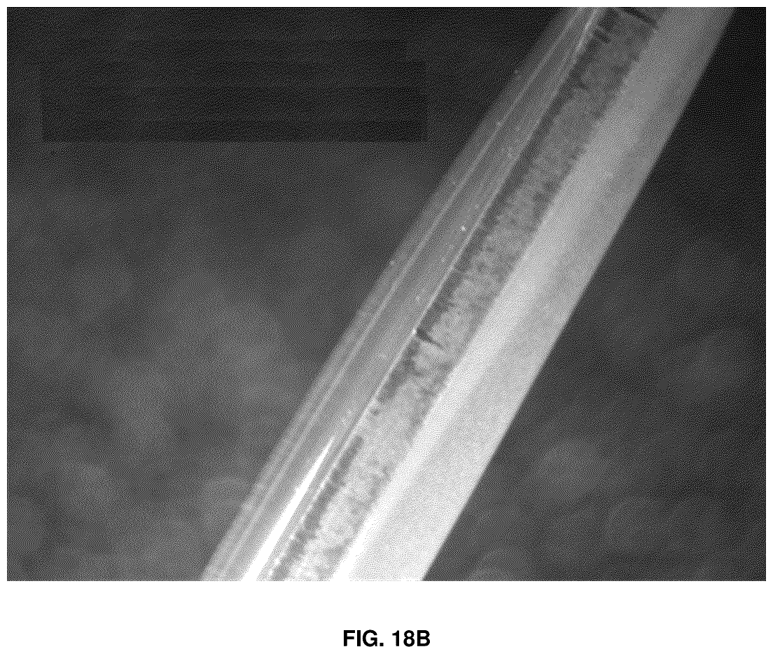

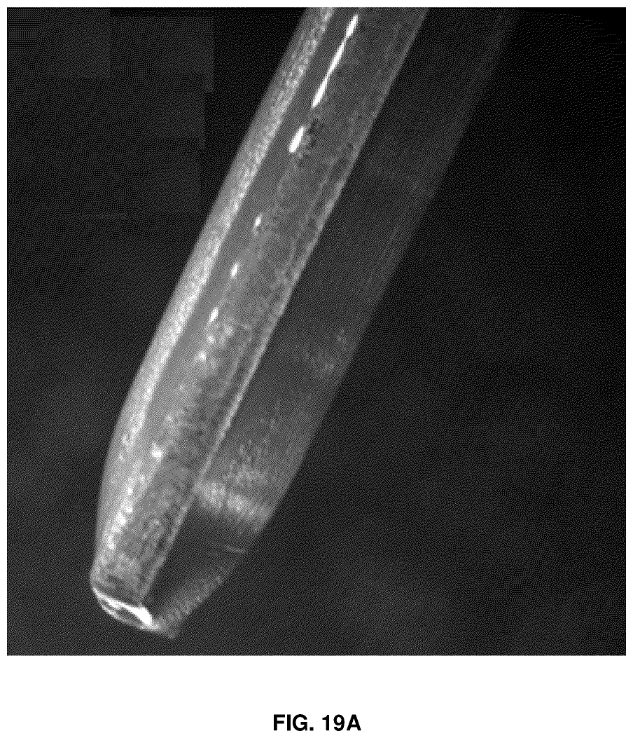

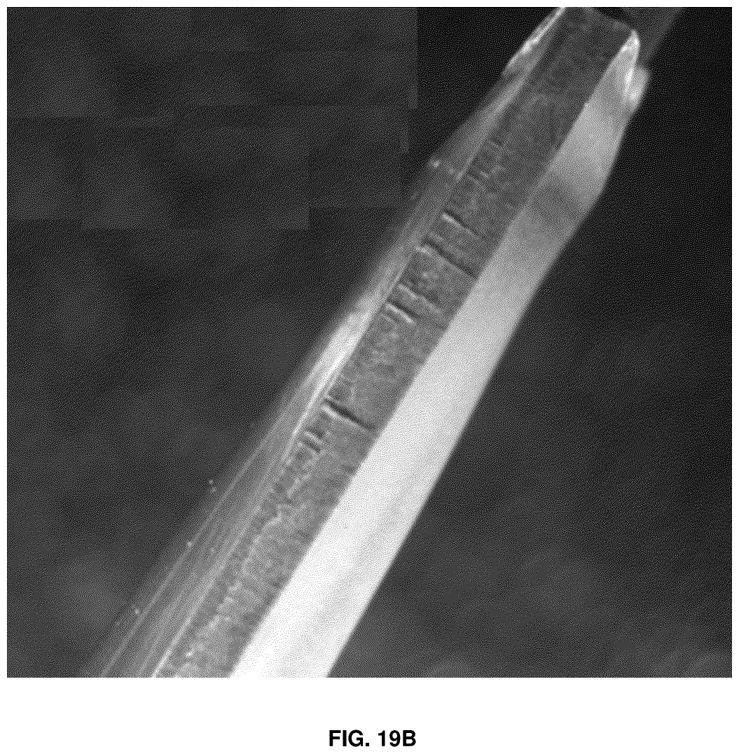

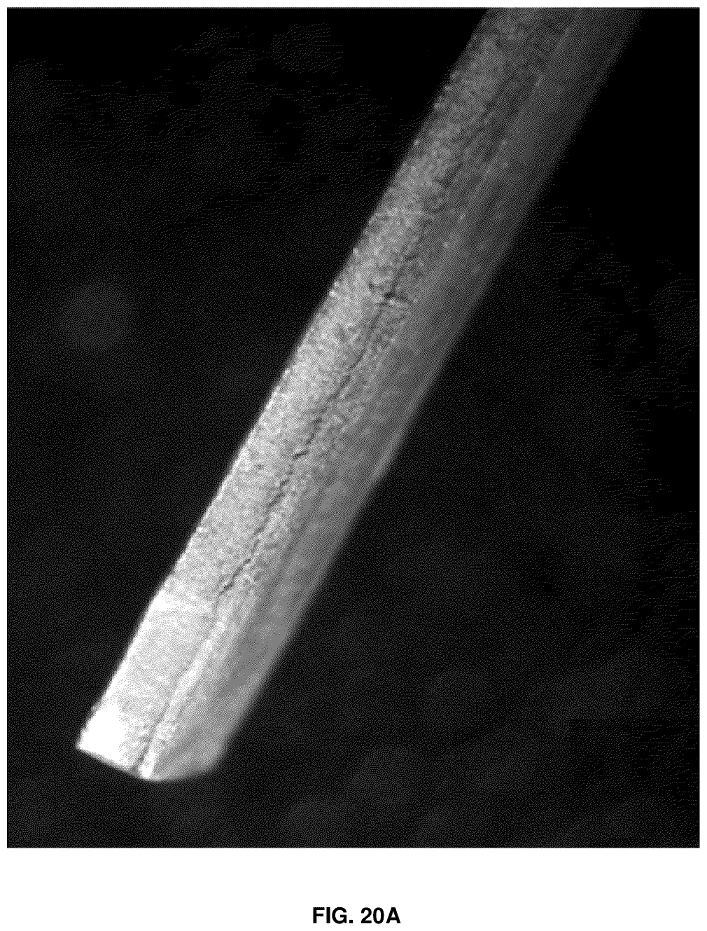

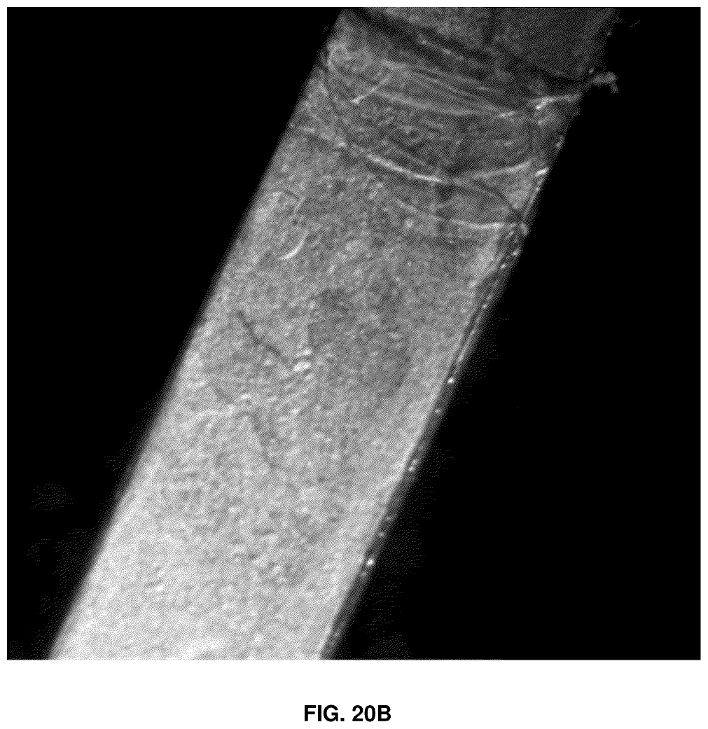

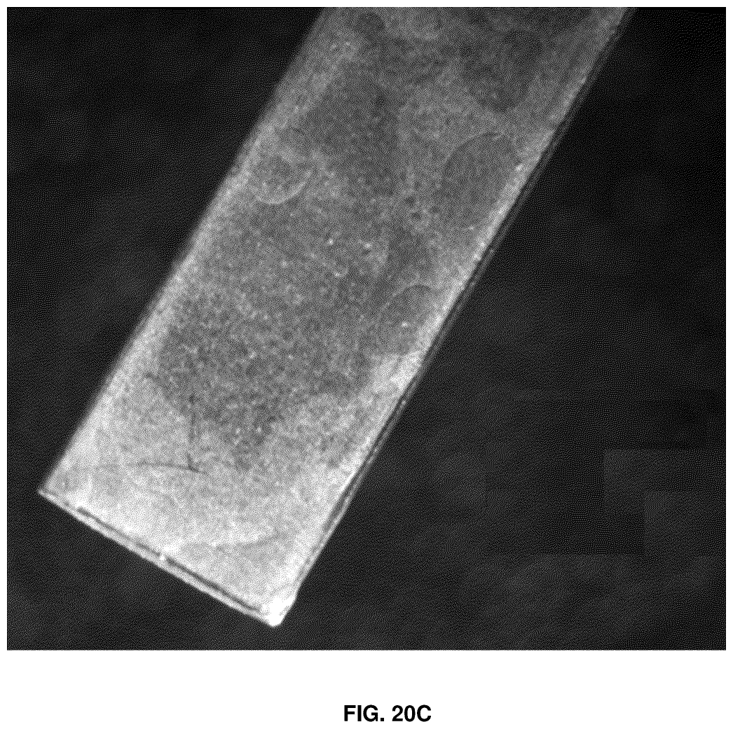

During the initial stages of coating development, HCl-etched stainless steel blades were coated directly with alginic acid. However, it was observed that the coating was not adhering to the stainless steel properly and scaling was also observed during the oven drying process. FIGS. 13A-13B and FIGS. 14A-14B show the microscopic images of coated blades before and after being immersed in ultra-pure water for 48 hrs. According to observation, the coating was detached from the blade and dissolved during immersion of 48 hrs. in water. However, stainless steel surfaces can be primed with a compound capable of tightly interacting with alginic acid. Tannic acid-based anchors are a viable option for surface functionalization of stainless-steel surfaces. Tannic acid is useful as an initial primer over stainless steel prior for functionalizing the surface. Deposition of tannic acid on the stainless-steel surface provided a rough surface to start the first layer of the alginic coating (FIG. 15A and FIG. 15B). It was helpful to tightly adhere the alginic acid layer to the blade surface. Tannic acid is easily anchored to the surface of stainless steel through its trihydroxyphenyl moiety via metal chelation to form a tridentate coordination complex layer. In addition, tannic acid can also chelate Ca²⁺ ions. The interaction between tannic acid, Ca²⁺ ions, and alginic acid is illustrated in FIG. 16. As part of the coating preparation process, Ca²⁺ ions were used to crosslink the tannic acid layer to the first alginic acid layer, as well as to crosslink the other alginic acid layers to each other. Following the priming of the etched blades with tannic acid and the application of alginic acid layers, swelling studies were again performed in water and organic solvents for one week. In FIGS. 17A-17B, FIGS. 18A-18B, and FIGS. 19A-19B, the coating is shown before and after it was placed in water and a MeOH:ACN mixture at a volume ratio of 1:1. It was found that the coating remained stable in both water and organic solvents for at least 7 days. Furthermore, the priming of stainless steel with tannic acid enhanced the durability of the coating during the oven drying process. FIGS. 20A-20C show microscopic images of dry alginic acid coated blades before and after immersion for a week in water and a 1:1 (v:v) mixture of MeOH and ACN.

### Desorption of the Wet Alginic Acid Coated Blades

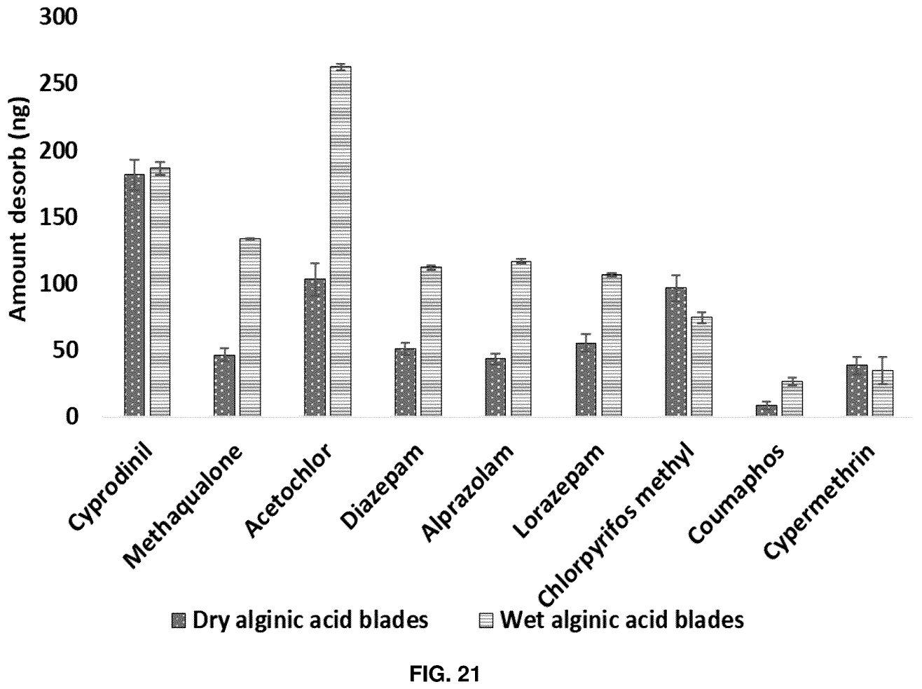

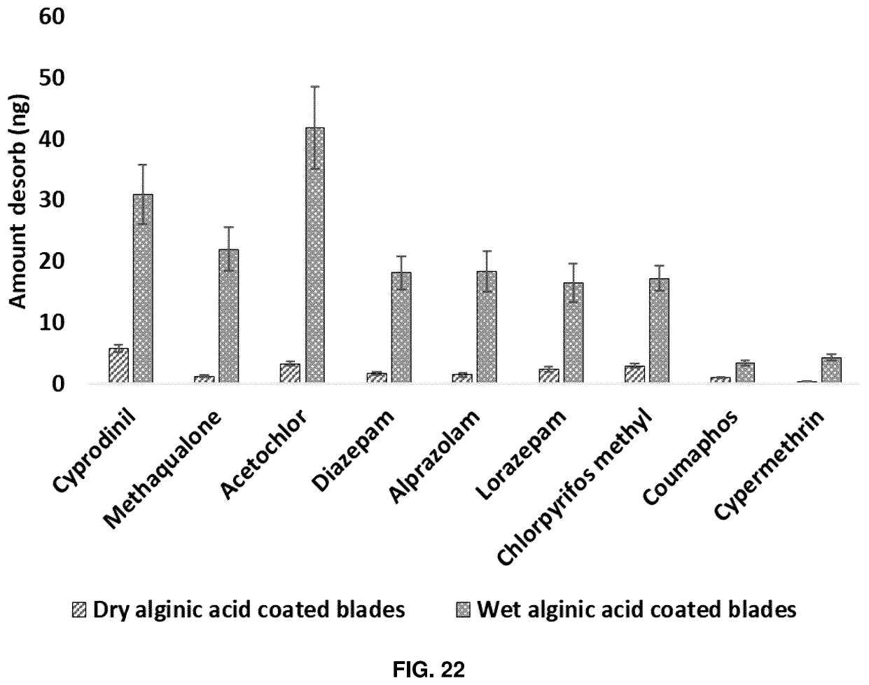

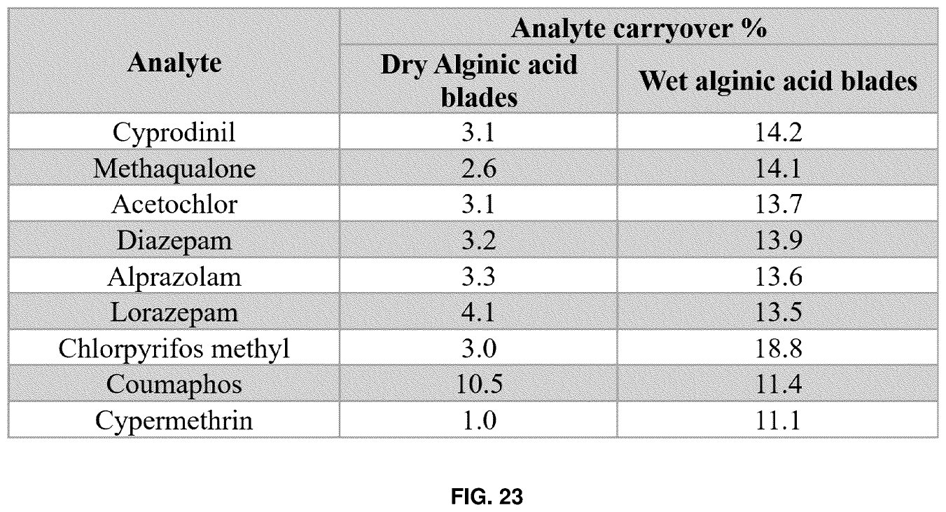

Analyte extraction was conducted using both wet and dry alginic acid coated blades and the amount of analytes extracted was calculated. FIG. 21 shows the amount of analytes (ng) desorbed from both coatings (ng) during the first desorption. In order to investigate the analyte carryover in blade coatings, a second desorption was conducted. FIG. 22 shows the amount of analyte desorbed during the second desorption and FIG. 23 shows the percent carryover for both dry and wet alginic acid coatings. Dry alginic acid coated blades had lower analytes carryover (<5% except for coumaphos) compared to the wet alginic acid coating which ranged from 11%-19%. It is possible that the mass transfer of analytes from the extraction phase to the desorption solution could be slow with wet alginic acid coatings because they were thick and bulky.

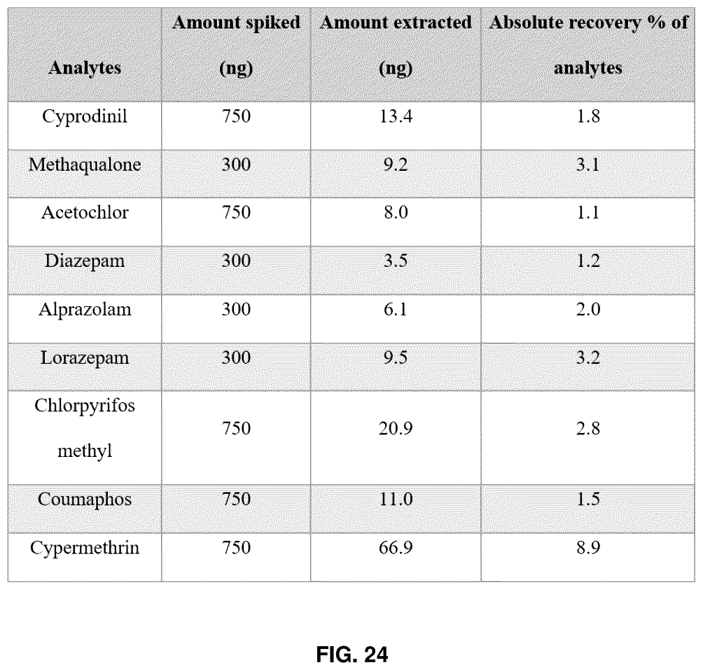

To determine the absolute recovery of analytes for wet alginate coatings, the coating was desorbed into the desorption solutions until the analytes were completely desorbed from the extraction phase. A total of six consecutive desorptions were utilized for analytes to be completely desorbed from the coating. Based on the cumulative amount of analytes obtained from six desorption, the absolute recovery of each analyte was calculated (FIG. 24).

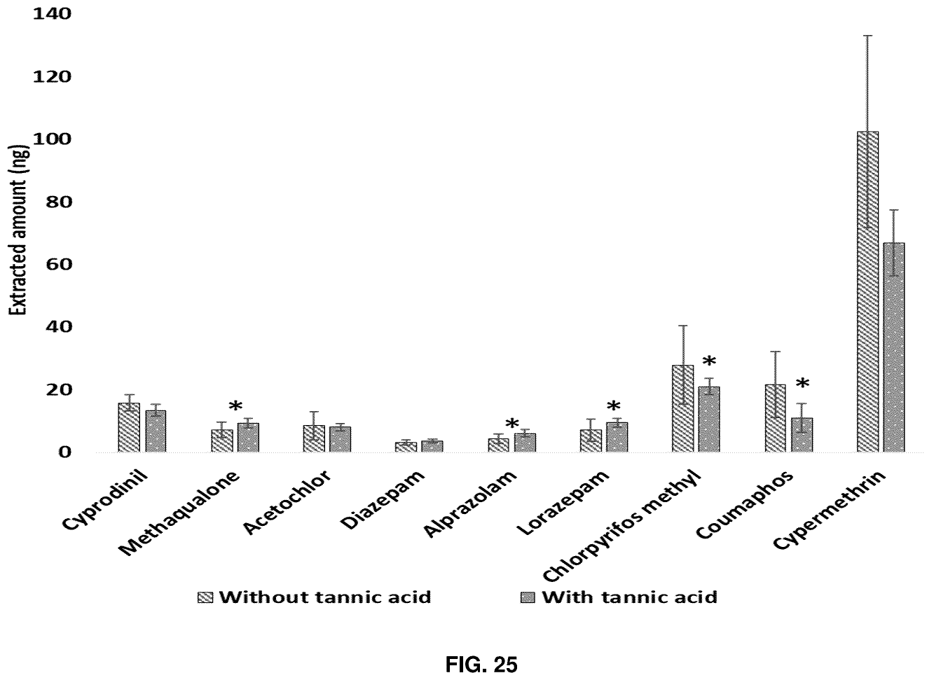

Tannic acid, which was used to prime stainless steel surfaces, contains phenolic hydroxyl groups that can contribute to the extraction of analytes. In order to determine whether the tannic acid layer plays a role in analyte extraction, blades were coated with and without tannic acid. Following that, both types of blades were utilized for analyte extraction. FIG. 25 shows the amount of analytes extracted from stainless steel coated using wet alginic acid with and without priming in tannic acid. The amount of analytes extracted from both coatings was not statistically different, indicating that the tannic acid layer on the stainless steel blade did not play a role in the analyte extraction process. A coating made without priming stainless steel, however, showed a lower reproducibility for analyte extraction than a coating made with the primer. It is difficult to apply the coating evenly on stainless steel without first priming the stainless steel with tannic acid. A decrease in reproducibility in analyte extraction may be attributed to the uneven coating that was formed during the coating process due to the lack of priming with tannic acid.

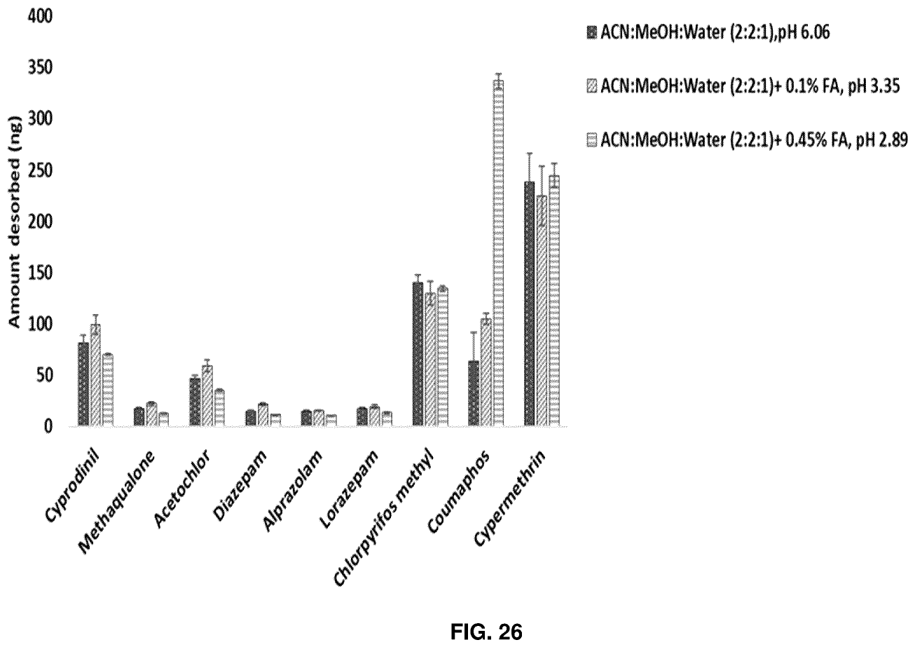

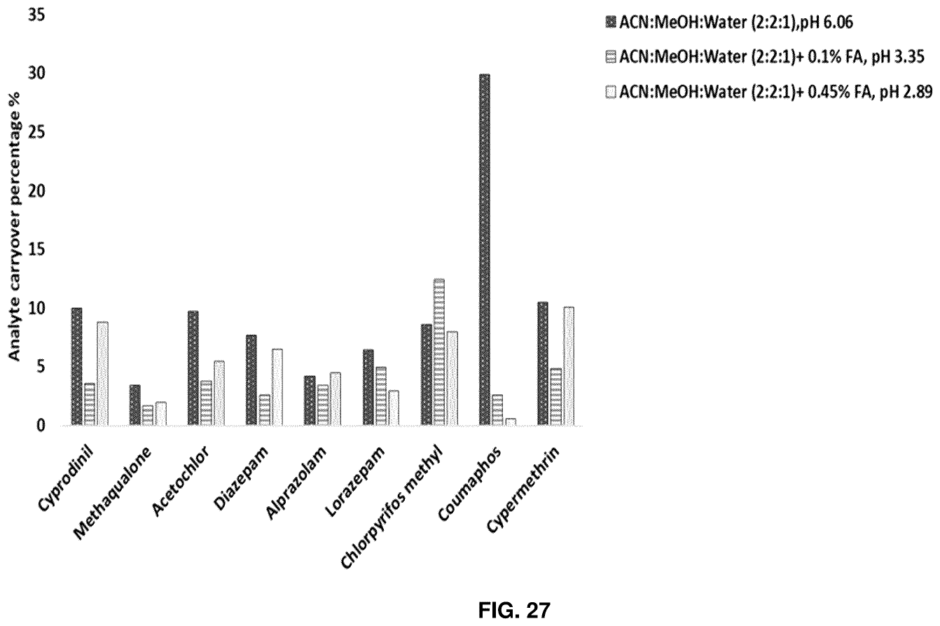

To increase the desorption efficiency of analytes from wet alginic acid coated blades, 1.5 mL of desorption solution was applied instead of the 400 μL previously, in an effort to enhance the ratio of desorption volume to extraction phase. Furthermore, the effect of desorption solution pH on analyte desorption efficiencies was evaluated. By adding formic acid to the desorption solution, the pH of the desorption solution was adjusted to values of 2.89 and 3.35. Formic acid percentages were 0.1% and 0.45% for pH values of 2.89 and 3.35. The pH of the desorption solution (MeOH:ACN:water (v:v:v) of 2:2:1) without formic acid was measured as 6.06. The pH of 2.89 was selected for this example since it is the pKa of alginic acid. It was believed that when the carboxylic acid groups of alginic acid are neutral, it can weaken the interaction between the analytes and the extraction phase to effectively desorb analytes to the desorption solution. FIG. 26 shows the amounts of analytes desorbed from the wet alginic acid coated blade to desorption solutions at different pH levels. The percentage of analyte carryover in the coating during the desorption in each pH level of the desorption solutions was illustrated in FIG. 27. Based on the results shown in FIG. 26 and FIG. 27, the desorption of analytes from blade coatings was not affected by pH, except for coumaphos. At every pH level tested for desorption solution, all analytes were neutral, and it was confirmed that neutralizing the carboxylic group of alginic acid was not helpful in desorbing the selected analytes. Furthermore, it was confirmed that analytes did not form ionic interactions with the negatively charged deprotonated carboxylic groups during extraction. Nevertheless, desorption solutions with a lower pH would help positively charged analytes to desorb from the coating.

### Determination of Analyte-to-Extraction Phase Partition Coefficients

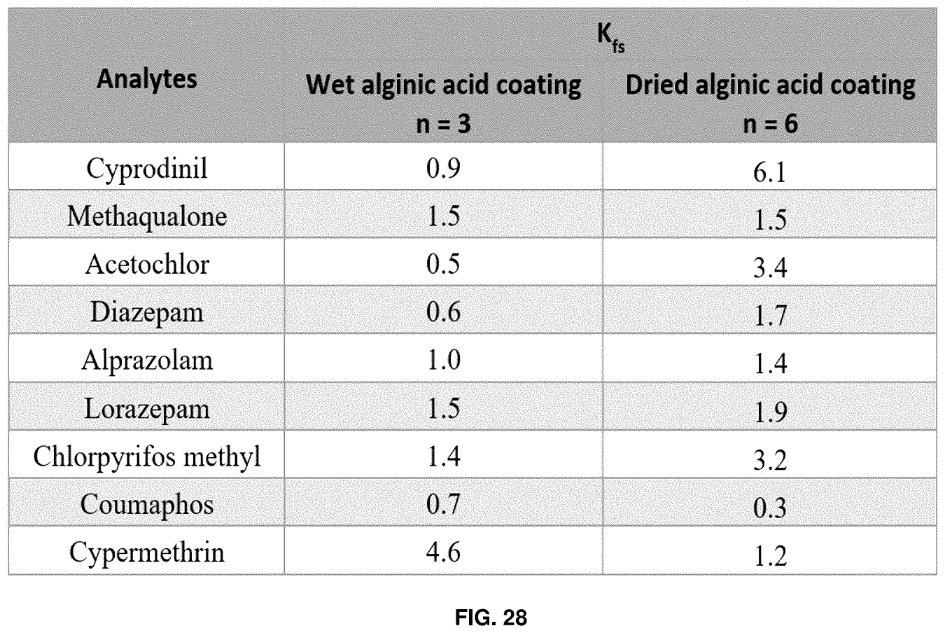

In an attempt to correlate the chemical makeup of the sorbent coating and selectivity, the analyte-to-coating partition coefficients were determined. Analyte partition coefficient to extraction phase (K_{fs}) was calculated using equation 1 described above. For wet alginic acid coated blades, K_{fs} was calculated using n_{f} as the total amount of analytes desorbed over six consecutive cycles of desorption. Due to the lack of analyte carryover in the third desorption, the amount of analytes extracted onto the dried alginic acid coating was determined by considering the total amount of analytes desorbed during the first and second desorption. Microscopic measuring tools were used to determine the coating thickness. In FIG. 28, the calculated analyte-to-extraction phase partition coefficients are listed for each analyte.

A comparison of K_{fs} values obtained from dried and wet alginic acid coatings showed that dried coatings had a higher K_{fs} value than wet coatings, with the exception of coumaphos, cypermethrin, and methaqualone. The wet alginic acid coating is a gel type bulky coating and mass transfer of analytes to the coating could be less efficient than in the thin dried alginic acid coating. When the coating is dried, the pore size of the alginic acid coating can be smaller than when it is wet, therefore bulky analytes may not partition well into the dried alginic acid coating.

### Analyte Extraction Efficiency as a Function of Multiple Layers of Alginic Acid Coating

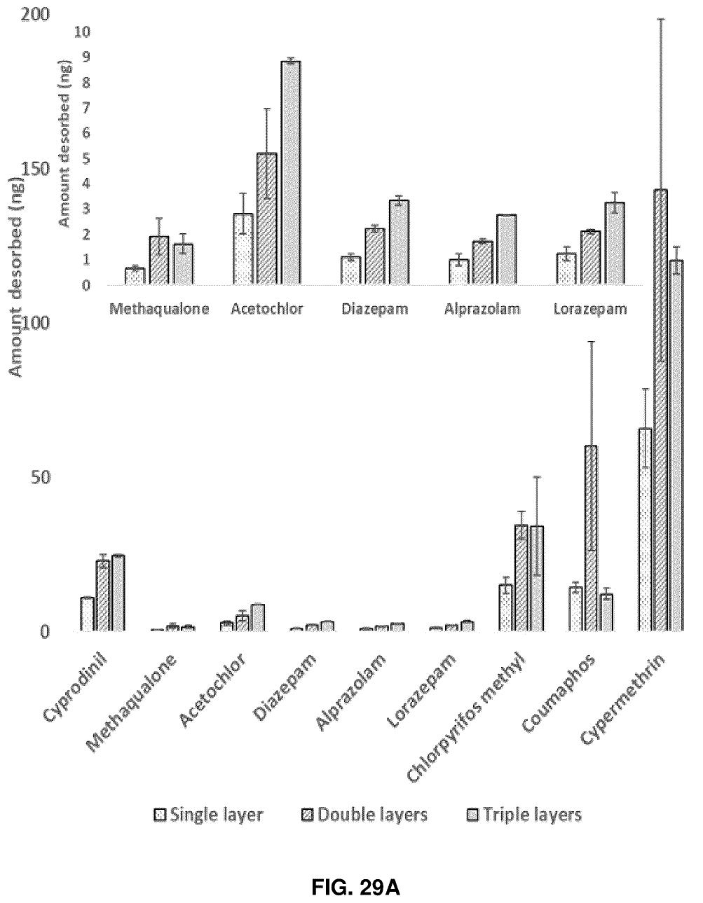

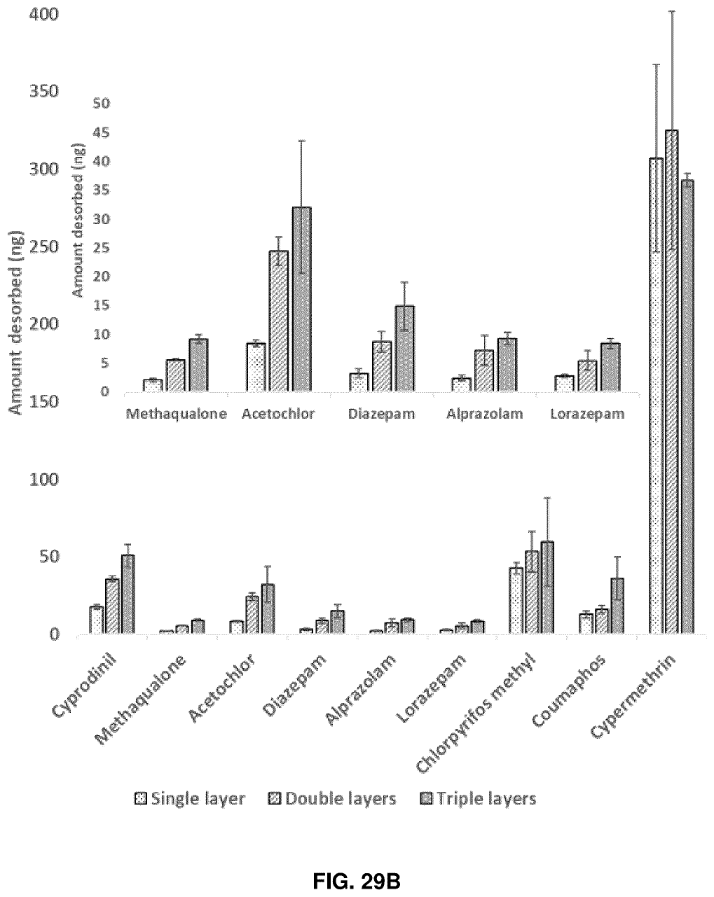

To determine the number of layers of alginic acid coating necessary for the extraction of analytes as well as the desorption from different layers of coating, a series of experiments was conducted. Using the dip coating method, both dry alginic acid layers and wet alginic acid layers were coated with different numbers of layers (single, double, triple layers). Following the analyte extraction with prepared alginic acid coatings, 500 μL of desorption solution was used to desorb the sample (FIGS. 29A-29B). When dry alginic acid coatings are applied (FIG. 29A), double and triple layers of alginic acid coatings extract greater amounts of analytes than single layer coated alginic acid coatings. Compared to double layer dry alginic acid coatings, triple layer dry alginic acid coatings were able to extract more acetochlor, diazepam, alprazolam, and lorazepam. In comparison to single and triple layer alginic acid coated extraction phases, methaqualone, cyprodinil, and cypermethrin were extracted in similar amounts from both layers of coated alginic acid, while coumaphos was extracted in higher amounts from double layer coated alginic acid.

Using wet alginic acid for extraction (FIG. 29B), both double layer and triple layer alginic acid extracted a greater quantity of analytes than a single layer alginic acid coating, and the amount of analytes extracted from double and triple layer wet alginic acid coated extraction phases was not significantly different.

Extraction from Simulated Sea Water

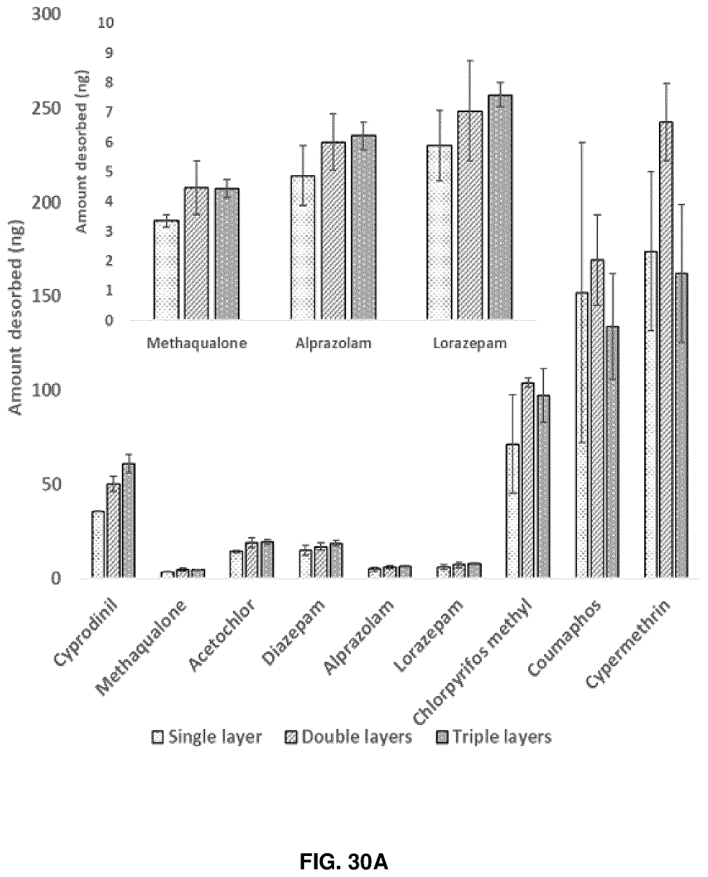

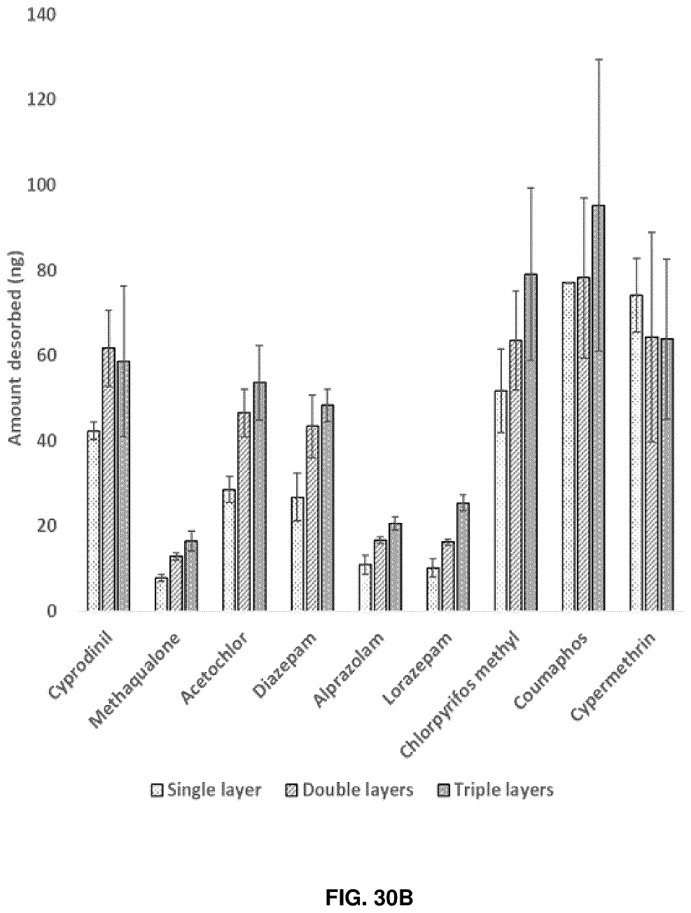

In order to determine the suitability of alginic acid coated blades to extract analytes from seawater, analytes spiked into simulated seawater were extracted using both dry and wet alginic acid coated blades (FIGS. 30A-30B). Analytes were successfully extracted from sea water with both dry and wet alginic acid coatings. The extraction of most analytes from wet and dry alginic acid coatings was lower with a single layer coating than with a double layer coating and a triple layer coating. Also, both the triple layer coating and the double layer coating extracted a similar amount of analytes.

Comparison of the Extraction of Analytes from Sea Water and Ultra-Pure Water

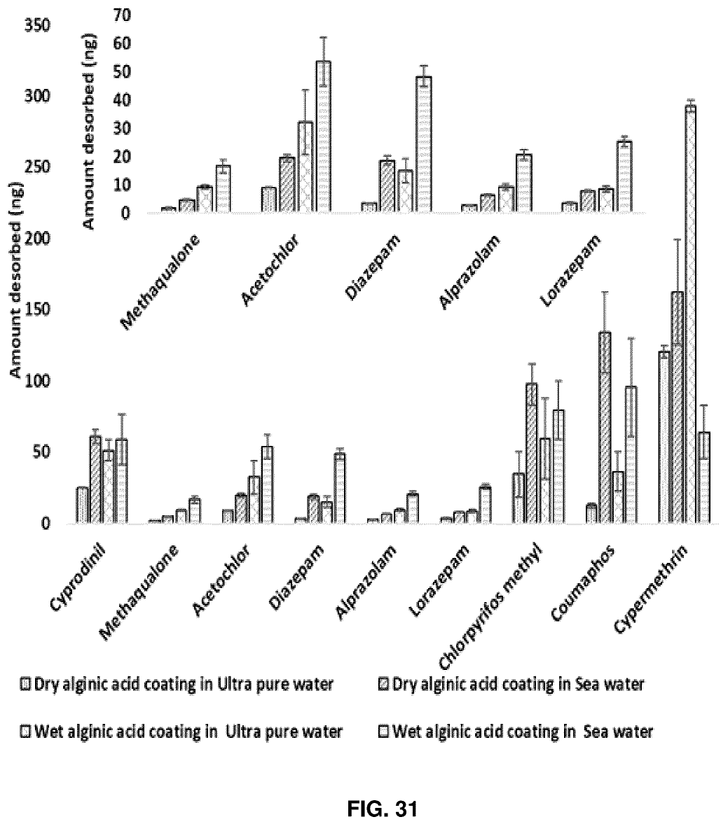

Analytes extraction with triple layer alginic acid coating from ultra-pure water and simulated sea water was conducted. The results are shown in FIG. 31. In ultra-pure water, a lesser amount of analytes was extracted than in seawater due to the high ionic strength of the seawater, which causes salting out effects on analytes, increasing the amount of analytes extracted into the alginic acid coating. This effect is dependent on the chemistry of the sample rather than the chemistry of the extraction phase (alginic acid).

Structure-wise, the blades produced resemble the amorphous embedded matrix of brown algae's outer cell wall, where the highest amount of alginate can be found. By applying the solid phase microextraction apparatus, xenobiotics can be extracted from ultra-pure water. The apparatus can be used to monitor xenobiotic bioaccumulation in marine brown algae. Prior to applying this device to seawater extraction, it is important to assess the effect of ionic strength in the sample matrix on the extraction of analytes.

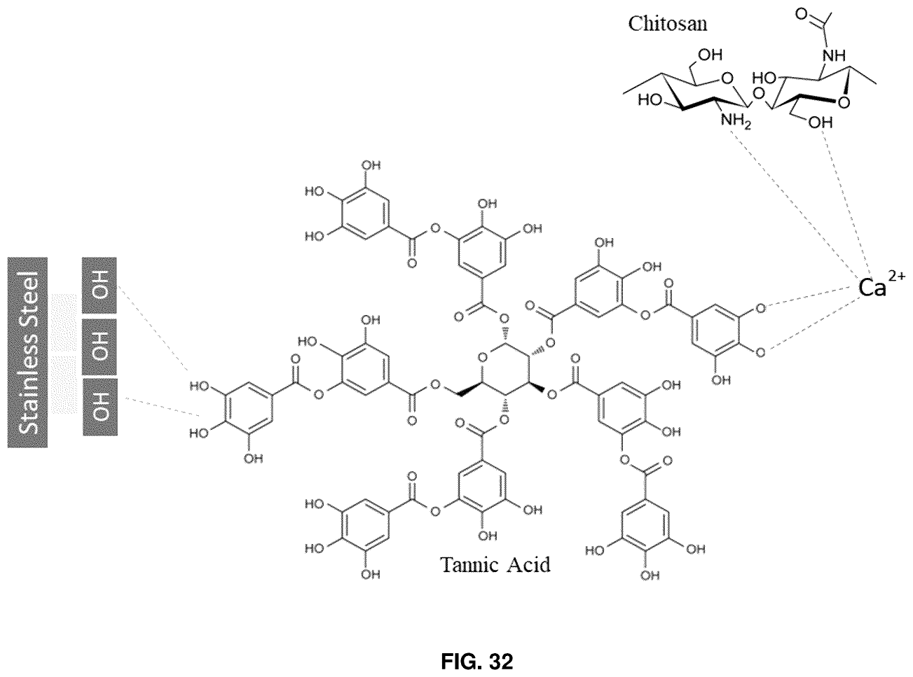

Tannic Acid easily anchors to the surface of stainless steel through its trihydroxyphenol moiety via metal chelation to form a tridentate coordination complex layer. Additionally, tannic acid has the ability to interact with biopolymers such as chitosan, as hydrogen bonding can be formed between the —OH and —NH₂ groups of the chitosan with the OH group of tannic acid. Moreover, non-covalent interactions such as van der Waals are formed, securing the initial anchorage. Chitosan and tannic acid contain a large number of hydroxy groups, allowing for hydrogen bonding to form easily. Both have also been demonstrated to chelate Ca²⁺ ions. The interaction between tannic acid, Ca²⁺ ions, and chitosan is illustrated in FIG. 32. As part of the coating preparation processes a saturated solution of 9.5 w/v % calcium tannate was used to crosslink the layers of chitosan to each other as well as layers of chitin to one another.

### Example II—Chitosan Coatings

### Preparation of Chitosan Slurry

To prepare 2.0% (w/v) chitosan slurry, 200 μL of acetic acid was added to a vial containing ultrapure H₂O along with a stir bar for around 30 minutes to allow time for equilibration to form a 2% acetic acid and H₂O solution. Then, using an analytical balance, 0.2041 g of chitosan was added to the vial and the mixture was allowed to stir until fully mixed. Once the entire solution was homogenized, the stir bar was removed, and the solution was sonicated until all air bubbles were removed. The solution was stored in the refrigerator until use.

### Preparation of Tannic Acid

To prepare 0.6 M NaCl solution, 1.7532 g of NaCl was added to a 50 volumetric flask containing a stir bar. The flask was then filled to the line with ultrapure water and allowed to stir. Then 0.27 g of tannic acid was added to a stirring Erlenmeyer flask containing the 0.6 M NaCl solution. The tannic acid was added in 0.09 g increments. Once all portions were added, the flask was parafilmed and allowed to stir until homogenized.

### Preparation of Calcium Tannate

To prepare the calcium tannate solution, 3.3252 g of CaCl₂ was added to a 50 mL volumetric flask containing a stir bar. The flask was then filled to the line using ultrapure water and allowed to stir. Once fully mixed, the 0.6 M CaCl₂ solution was transferred to a 250 mL Erlenmeyer flask. 0.27 g of tannic acid was added to the stirring Erlenmeyer flask. This was added in 0.09 increments. Once all portions were added, the flask was parafilmed and allowed to stir until homogenized.

### Preparation of Stainless-Steel Blades

In order to etch the stainless-steel blades, the blades were sonicated in 36% (w/w) hydrochloric acid (HCl) solution for 12 min. After 6 minutes, the blades were flipped to ensure even coating. The acid was then removed. The blades were then sonicated for 10 min in water, acetone, and ethanol solutions, sequentially. Next, the blades were dried at 70-80° C. in a laboratory oven. In order to prime the stainless-steel blade, 1.2 mL of the tannic acid solution was added to a 2 mL vial, and the blade was inserted into the vial via a slit cut into the vial cap. The vial was then agitated at 1000 rpm for 12 hours.

### Blade Coating Procedure

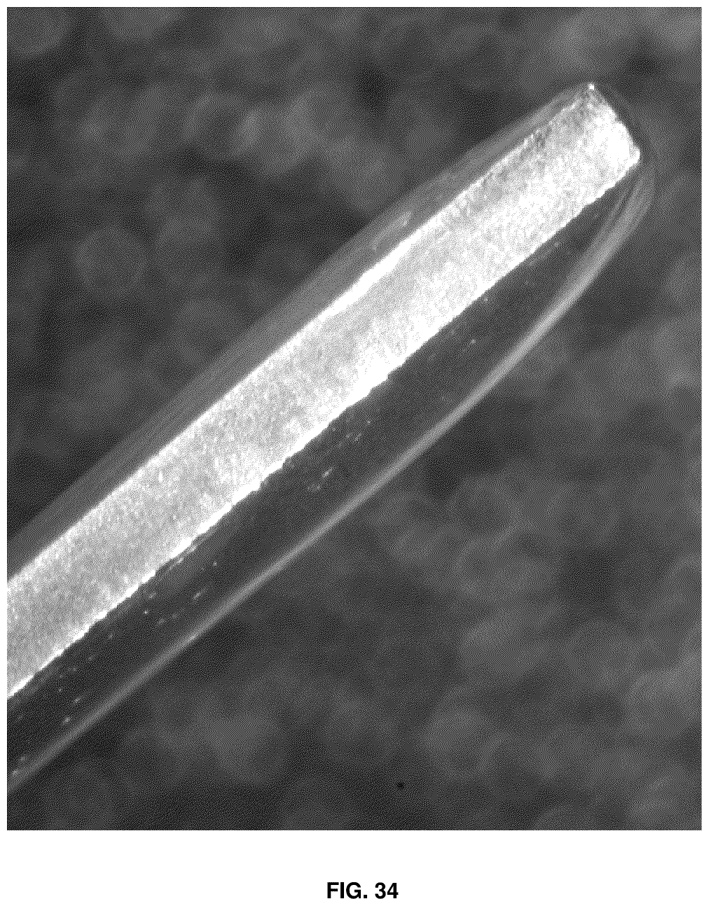

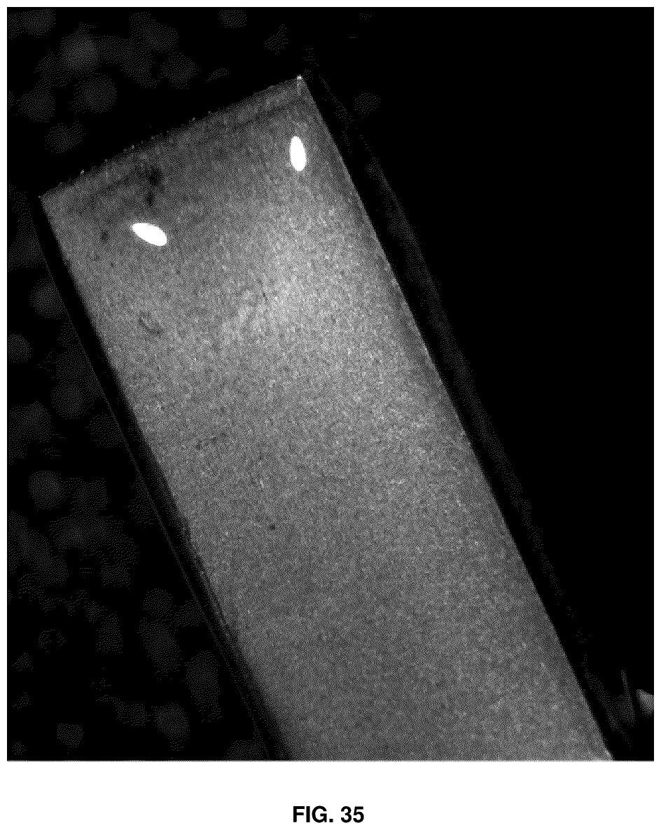

Blades were removed from the tannic acid solution and dipped into the 2.0% (w/v) chitosan slurry. The blades were carefully dipped and held in an upright position. The blades were slowly and incrementally removed from the chitosan slurry to mitigate against irregular coating. The blades were then immediately placed in the calcium-tannate solution for 90 seconds. After 90 seconds, the blades were allowed to dry for a few moments before being placed into ultrapure water for 30 seconds. Examples of chitosan-based microextraction apparatuses are shown in FIGS. 34-35. Further chitosan layers can be added to the blade by repeating the chitosan dip steps and the calcium tannate dip steps.

### Example of Procedure for Creation of Chitosan-Based Microextraction Apparatus

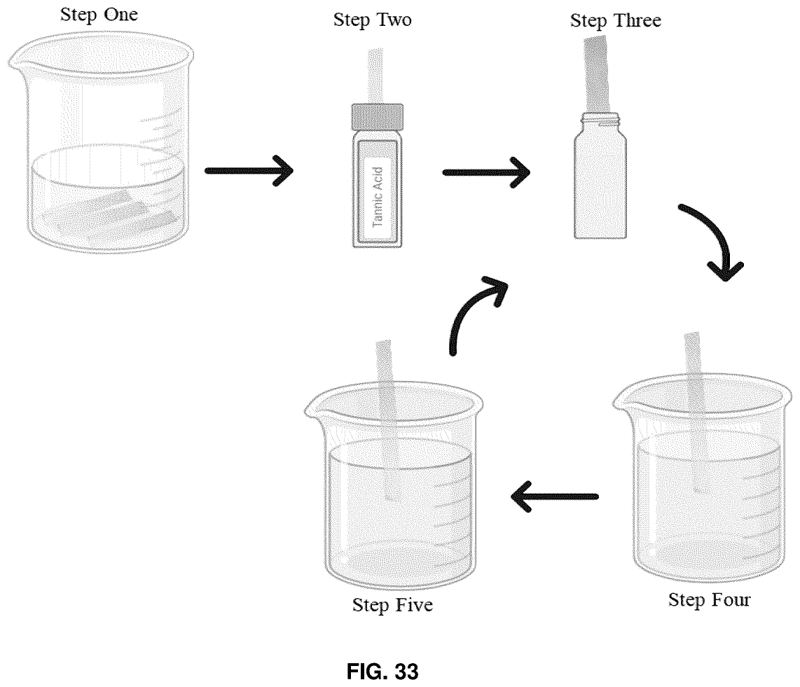

FIG. 33 shows the procedure for creating chitosan-based microextraction apparatuses as used in this example, which includes six steps. Step one is sociating blades in 36 w/v % HCl followed by a series of organic solvents for 10 minutes before drying in an oven at 60° C. Step two is placing dried blades in vials containing tannic acid and allowing agitation at 1000 rpm overnight. Step three is removing the blades from the tannic acid and dipping the blades in a solution of 2.0% (w/v) chitosan. Step four is holding chitosan-coated blades in a solution of saturated calcium tannate for 90 seconds. Step five is placing the blades in ultrapure water for 30 seconds to remove excess salt. Step six is optional and involves repeating steps three to five until the desired number of coats is achieved.

### Example III—Chitin Coatings

### Preparation of Chitin Slurry

To prepare 1.6% (w/v) chitin slurry, 19 mL of N,N,N-dimethyl acetamide was added to a vial. LiCl was weighted out and 0.5 g of dry LiCl was added to the vial. The solution was then stirred, using a stir bar, until the LiCl was fully dissolved to form a 5% LiCl/DMac solution. This can take from one to three hours. Then, using an analytical balance, 0.16260 g of chitin was added to the LiCl/DMac solution. The vial was then parafilmed and allowed to stir until fully homogenized. This can take up to about five hours. Once the entire solution was homogenized, the stir bar was removed, and the solution was sonicated until all air bubbles were removed. The solution was stored in the refrigerator until use.

### Preparation of Tannic Acid

To prepare 0.6 M NaCl solution, 1.7532 g of NaCl was added to a 50 volumetric flask containing a stir bar. The flask was then filled to the line with ultrapure water and allowed to stir. Then 0.27 g of tannic acid was added to a stirring Erlenmeyer containing the 0.6 M NaCl solution. The tannic acid was added in 0.09 g increments. Once all portions were added, the flask was parafilmed and allowed to stir until homogenized.

### Preparation of Stainless-Steel Blades

In order to etch the stainless-steel blades, blades were sonicated in 36% (w/w) hydrochloric acid (HCl) solution for 12 min. After 6 minutes, the blades were flipped to ensure even coating. The acid was then removed. The blades were then sonicated for 10 min in water, acetone, and ethanol solutions, sequentially. Next, the blades were dried at 70-80° C. in a laboratory oven. In order to prime the stainless-steel blade, 1.2 mL of the tannic acid solution was added to a 2 mL vial, and the blade was inserted into the vial via a slit cut into the vial cap. The vial was then agitated at 1000 rpm for 12 hours.

### Preparation of Chitosan Primer

To prepare 1.0% (w/v) chitosan primer, 200 μL of acetic acid was added to a vial containing ultrapure H₂O along with a stir bar for around 30 minutes to allow time for equilibration to form a 2% acetic acid and H₂O solution. Then, using an analytical balance, 0.1010 g of chitosan was added to the vial and allowed to stir until fully mixed. Once the entire solution was homogenized, the stir bar was removed, and the solution was sonicated until all air bubbles were removed. The solution was stored in the refrigerator until use.

### Preparation of Calcium-Tannate Solution

To prepare the calcium-tannate solution, 3.3252 g of CaCl₂ was added to a 50 mL volumetric flash containing a stir bar. The flask was then filled to the line using ultrapure water and allowed to stir. Once fully mixed, the 0.6 M CaCl₂ solution was transferred to a 250 mL Erlenmeyer flask. 0.27 g of tannic acid was added to the stirring Erlenmeyer flask. This was added in 0.09 increments. Once all portions were added, the flask was parafilmed and allowed to stir until homogenized.

### Blade Coating Procedure

Blades were removed from the tannic acid solution and dipped into the 1.0% (w/v) chitosan primer. The blades were carefully dipped and held in an upright position. The blades were slowly and incrementally removed from the chitosan solution to mitigate against irregular coating. The blades were then immediately placed in the calcium-tannate solution for 90 seconds. After 90 seconds, the blades were allowed to dry for a few moments before placing into ultrapure water for 30 seconds. The blades were then allowed to rest for 30 to 60 seconds before being placed in the 1.6% (w/v) chitin slurry. The blades were carefully dipped and held in an upright position. The blades were slowly and incrementally removed from the chitin slurry to mitigate against irregular coating. Afterwards, the blades were dipped into the calcium-tannate solution for 90 seconds. The blades were then allowed to rest for 30 seconds before being placed into ultrapure water for 30 seconds. Further chitin layers can be added to the blade by repeating the chitin slurry dip steps and the calcium tannate dip steps.

### Example of Procedure for Creation of Chitin-Based Microextraction Apparatus

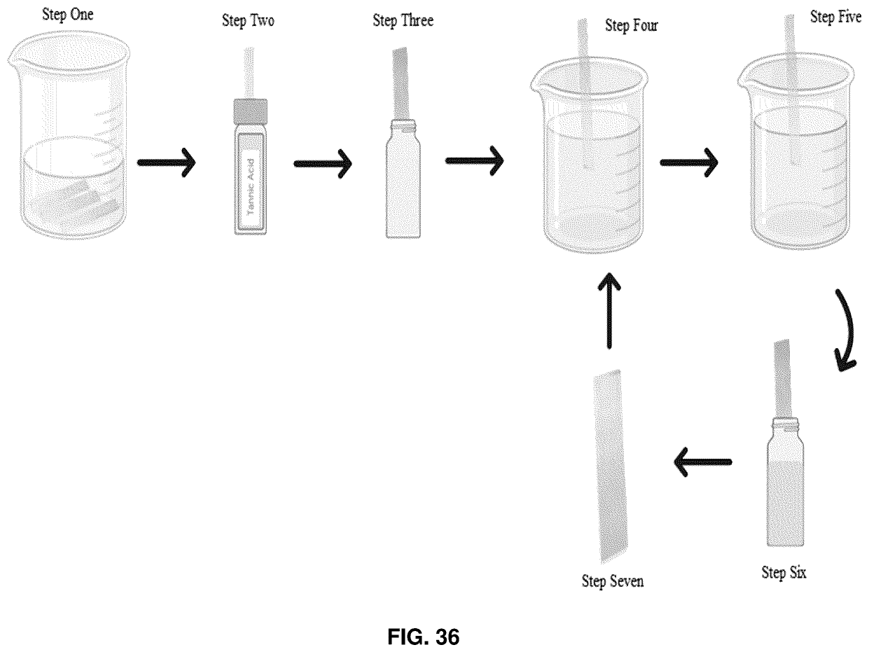

FIG. 36 illustrates the procedure used in this example for creating chitin-based microextraction apparatuses, which includes seven steps. Step one is sonicating the blades in 36% (w/v) HCl followed by a series of organic solvents for 10 minutes before drying in an oven at 60° C. Step two is placing dried blades in vials containing tannic acid and allowing agitation at 1000 rpm overnight. Step three is removing the blades from tannic acid and dipped in a solution of 1.0% (w/v) chitosan. Step four is holding the chitosan-coated blades in a solution of saturated calcium tannate for 90 seconds. Step five is placing the blades in ultrapure water for 30 seconds to remove excess salt. Step six is carefully dipping the blades in 1.6 w/v % chitin slurry. Step seven is optional and involves repeating steps four to six until the desired number of coats is achieved.

Certain embodiments of the apparatuses and methods disclosed herein are defined in the above examples. It should be understood that these examples, while indicating particular embodiments of the invention, are given by way of illustration only. From the above discussion and these examples, one skilled in the art can ascertain the essential characteristics of this disclosure, and without departing from the spirit and scope thereof, can make various changes and modifications to adapt the devices and methods described herein to various usages and conditions. Various changes may be made, and equivalents may be substituted for elements thereof without departing from the essential scope of the disclosure. In addition, many modifications may be made to adapt a particular situation or material to the teachings of the disclosure without departing from the essential scope thereof.

What is claimed is:

1. A microextraction apparatus comprising:
a substrate;
an anchoring material directly on the substrate; and
an adsorption material attached to the anchoring material, wherein the adsorption material comprises a polysaccharide.

2. The microextraction apparatus of claim 1, wherein the anchoring material comprises a polyphenol.

3. The microextraction apparatus of claim 2, wherein the polyphenol is crosslinked.

4. The microextraction apparatus of claim 3, wherein the polyphenol is crosslinked with cations.

5. The microextraction apparatus of claim 4, wherein the cations are Ca²⁺ ions.

6. The microextraction apparatus of claim 1, wherein the anchoring material comprises tannic acid.

7. The microextraction apparatus of claim 1, wherein the substrate comprises stainless steel.

8. The microextraction apparatus of claim 1, wherein the polysaccharide is crosslinked.

9. The microextraction apparatus of claim 8, wherein the polysaccharide is crosslinked with cations.

10. The microextraction apparatus of claim 9, wherein the cations are Ca²⁺ ions.

11. The microextraction apparatus of claim 1, wherein the polysaccharide comprises alginic acid, chitosan, or chitin.

12. The microextraction apparatus of claim 1, wherein the anchoring material comprises tannic acid, and the polysaccharide comprises alginic acid.

13. The microextraction apparatus of claim 1, wherein the substrate comprises a metallic material.

14. The microextraction apparatus of claim 13, wherein the metallic material is stainless steel.

15. A method of assembling a microextraction apparatus, the method comprising:
depositing an anchoring material on a surface of a substrate to functionalize the surface, wherein the anchoring material comprises a polyphenol; and
depositing an adsorption material on the anchoring material, wherein the adsorption material comprises a polysaccharide.

16. The method of claim 15, further comprising etching the surface prior to functionalizing the surface.

17. The method of claim 15, further comprising crosslinking the polyphenol prior to depositing the adsorption material on the anchoring material.

18. The method of claim 15, further comprising crosslinking the polysaccharide.

19. The method of claim 15, wherein the polysaccharide comprises alginic acid, chitin, or chitosan.

20. The method of claim 15, wherein the polyphenol comprises tannic acid.
